(19) United States
(12) Patent Application Publication
(10) Pub. No.: US 2025/0324306 A1
(43) Pub. Date: Oct. 16, 2025

(54) DATA TRANSFER WITHIN CONNECTED MEASUREMENTS RADIO GAPS

(71) Applicant: Apple Inc., Cupertino, CA (US)

(72) Inventors: Amr Abdelrahman Yousef Abdelrahman Mostafa, Munich (DE); Alperen Gundogan, Munich (DE); Christian Hofmann, Munich (DE); Panagiotis Botsinis, Munich (DE); Sameh M. Eldessoki, Munich (DE); Tarik Tabet, Carlsbad, CA (US)

(73) Assignee: Apple Inc., Cupertino, CA (US)

(21) Appl. No.: 18/793,302

(22) Filed: Aug. 2, 2024

Related U.S. Application Data
(60) Provisional application No. 63/633,587, filed on Apr. 12, 2024.

(51) Int. Cl. H04W 24/10; H04L 1/1812; H04W 56/00

(52) U.S. Cl. CPC H04W 24/10; H04L 1/1812; H04W 56/0045

(57) ABSTRACT

The present application relates to devices and components including apparatus, systems, and methods to address interruption due to measurements radio gaps in wireless communication systems.

### CROSS-REFERENCE TO RELATED APPLICATIONS

This application claims priority to U.S. provisional application No. 63/633,587, entitled “Data Transfer within Connected Measurements Radio Gaps,” filed on Apr. 12, 2024, the disclosure of which is incorporated by reference herein in its entirety for all purposes.

### TECHNICAL FIELD

The present application relates to the field of wireless technologies and, in particular, to data transfer within connected measurements radio gaps.

### BACKGROUND

Third Generation Partnership Project (3GPP) networks allow for user equipments (UEs) to establish connections with cells. A UE may enter a connected state with cell, which may cause the cell to operate as a serving cell for the UE. The UE and the serving cell can exchange data to provide services with the UE.

While the UE is connected to the serving cell, it can be beneficial for the UE to perform measurements of other neighboring cells, where the measurements can be utilized for multiple operations, including whether a handover is to be performed for the UE to another cell. In order to perform these measurements of neighboring cells, data exchange between the serving cell and the UE need to be halted. Accordingly, the UE implements measurements radio gaps for performing the measurements, where data is prevented to be exchanged between the UE and the serving cell during the measurements radio gaps.

### BRIEF DESCRIPTION OF THE DRAWINGS

FIG. 1 illustrates a network environment in accordance with some embodiments.

FIG. 2 illustrates a user equipment (UE) in accordance with some embodiments.

FIG. 3 illustrates a network device in accordance with some embodiments.

FIG. 4 illustrates example measurements radio gap representations in accordance with some embodiments.

FIG. 5 illustrates example measurements radio gap representations showing data transfer within measurements radio gap (DTMRG) in accordance with some embodiments.

FIG. 6 illustrates a first portion of an example signaling chart showing DTMRG operation in accordance with some embodiments.

FIG. 7 illustrates a second portion of the example signaling chart showing DTMRG operation in accordance with some embodiments.

FIG. 8 illustrates an example DTMRG architecture in accordance with some embodiments.

FIG. 9 illustrates another example DTMRG architecture in accordance with some embodiments.

FIG. 10 illustrates example option representations for hybrid automatic repeat request (HARQ) feedback in accordance with some embodiments.

FIG. 11 illustrates an example DTMRG gaps assignments alignment representations in accordance with some embodiments.

FIG. 12 illustrates an example signaling chart implementing the first scheme in accordance with some embodiments.

FIG. 13 illustrates an example signaling chart implementing the second scheme in accordance with some embodiments.

FIG. 14 illustrates an example signaling chart implementing the third scheme in accordance with some embodiments.

FIG. 15 illustrates an example signaling chart illustrating a DTMRG gap instance approach in accordance with some embodiments.

FIG. 16 illustrates an example signaling chart showing the first option for adjusting a time advance in accordance with some embodiments.

FIG. 17 illustrates an example signaling chart showing the downlink (DL) transmission configuration in accordance with some embodiments.

FIG. 18 illustrates an example signaling chart showing skipping a radio measurement gap in accordance with some embodiments.

FIG. 19 illustrates an example procedure for exchanging data with a UE during a measurements radio gap in accordance with some embodiments.

FIG. 20 illustrates an example procedure for configuring a hosting cell and a UE for a data exchange during a measurements radio gap in accordance with some embodiments.

FIG. 21 illustrates an example procedure for performing a data exchange with a UE during a measurements radio gap in accordance with some embodiments.

FIG. 22 illustrates an example procedure for causing a UE to skip a next measurements radio gap in accordance with some embodiments.

FIG. 23 illustrates an example procedure for skipping a next measurements radio gap in accordance with some embodiments.

FIG. 24 illustrates an example procedure for enabling one or more measurements radio gaps in accordance with some embodiments.

FIG. 25 illustrates an example procedure for implementing one or more measurements radio gaps in accordance with some embodiments.

FIG. 26 illustrates an example measurement timing arrangement in accordance with some embodiments.

FIG. 27 illustrates an example procedure in accordance with some embodiments.

FIG. 28 illustrates an example measurement timing arrangement in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

The term “frequency” as used herein may indicate a frequency and/or a frequency range. For example, a first frequency may refer to a first frequency range and a second frequency may refer to a second frequency range.

While connected to a serving cell, a user equipment (UE) may be configured to perform measurements on one or more frequencies to identify neighboring cells operating at the frequencies. The UE may implement a measurements radio gap to perform these measurements on the one or more frequencies. In legacy embodiments, data was prevented from being exchanged between the UE and the serving cell during the measurements radio gap. However, it could be beneficial for service for data to be exchanged with the UE during the measurement radio gap, such as when time-sensitive data is to be exchanged with the UE and/or when pending data is to waiting to be exchanged with the UE until after the measurements radio gap. Approaches described herein can provide for the exchange of data between the serving cell during a measurements radio gap or during a time that was initially scheduled for a measurements radio gap. These approaches could result in approved service for the UE.

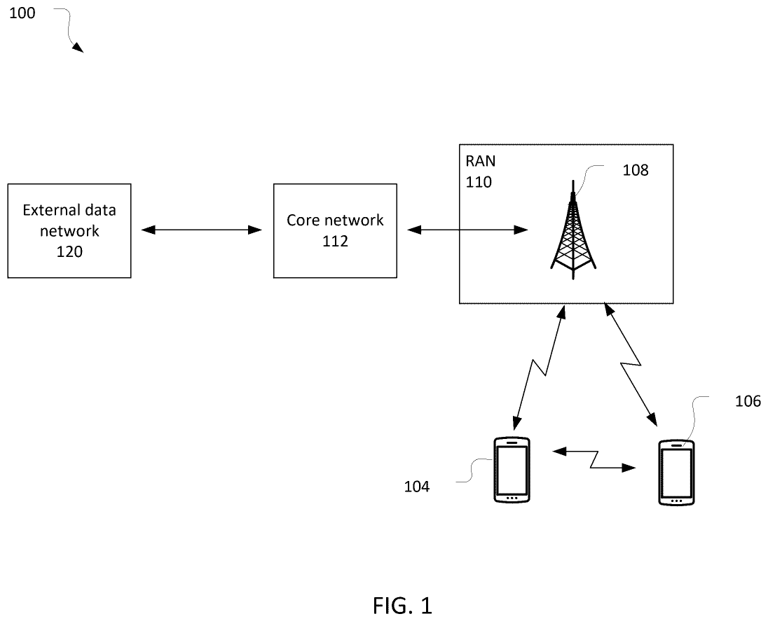

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104.

In some embodiments, the UE 104 and base station 108 may establish data radio bearers (DRBs) to support transmission of data over a wireless link between the two nodes. In one example, these DRBs may be used for traffic from extended reality (XR) applications that contains a large amount of data conveying real and virtual images and audio for presentation to a user.

The network environment 100 may further include a core network 112. For example, the core network 112 may comprise a 5^{th} Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

In some embodiments, the network environment 100 may also include UE 106. The UE 106 may be coupled with the UE 104 via a sidelink interface. In some embodiments, the UE 106 may act as a relay node to communicatively couple the UE 104 to the RAN 110. In other embodiments, the UE 106 and the UE 104 may represent end nodes of a communication link. For example, the UEs 104 and 106 may exchange data with one another.

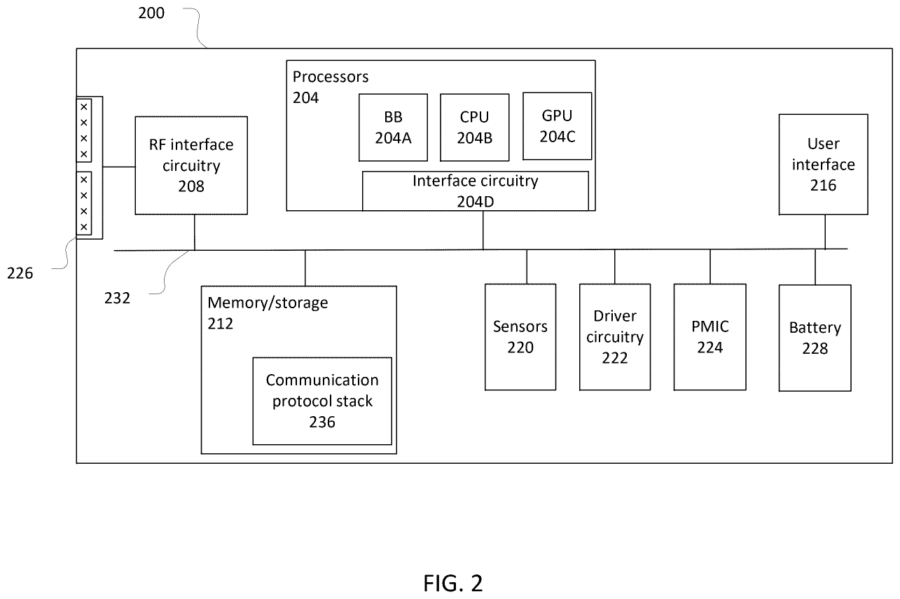

FIG. 2 illustrates a UE 200 in accordance with some embodiments. The UE 200 may be similar to and substantially interchangeable with UE 104 or 106.

The UE 200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 200 may include processors 204, RF interface circuitry 208, memory/storage 212, user interface 216, sensors 220, driver circuitry 222, power management integrated circuit (PMIC) 224, antenna 226, and battery 228. The components of the UE 200 may be implemented as integrated circuits (ICs), portions thereof, discrete electronic devices, or other modules, logic, hardware, software, firmware, or a combination thereof. The block diagram of FIG. 2 is intended to show a high-level view of some of the components of the UE 200. However, some of the components shown may be omitted, additional components may be present, and different arrangement of the components shown may occur in other implementations.

The components of the UE 200 may be coupled with various other components over one or more interconnects 232, which may represent any type of interface, input/output, bus (local, system, or expansion), transmission line, trace, or optical connection that allows various circuit components (on common or different chips or chipsets) to interact with one another.

The processors 204 may include processor circuitry such as, for example, baseband processor circuitry (BB) 204A, central processor unit circuitry (CPU) 204B, and graphics processor unit circuitry (GPU) 204C. The processors 204 may include any type of circuitry or processor circuitry that executes or otherwise operates computer-executable instructions, such as program code, software modules, or functional processes from memory/storage 212 to cause the UE 200 to perform delay-adaptive operations as described herein. The processors 204 may also include interface circuitry 204D to communicatively couple the processor circuitry with one or more other components of the UE 200.

In some embodiments, the baseband processor circuitry 204A may access a communication protocol stack 236 in the memory/storage 212 to communicate over a 3GPP compatible network. In general, the baseband processor circuitry 204A may access the communication protocol stack 236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 208.

The baseband processor circuitry 204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 212 may include one or more non-transitory, computer-readable media that includes instructions (for example, communication protocol stack 236) that may be executed by one or more of the processors 204 to cause the UE 200 to perform various delay-adaptive operations described herein.

The memory/storage 212 includes any type of volatile or non-volatile memory that may be distributed throughout the UE 200. In some embodiments, some of the memory/storage 212 may be located on the processors 204 themselves (for example, memory/storage 212 may be part of a chipset that corresponds to the baseband processor circuitry 204A), while other memory/storage 212 is external to the processors 204 but accessible thereto via a memory interface. The memory/storage 212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 208 may include transceiver circuitry and a radio frequency front module (RFEM) that allows the UE 200 to communicate with other devices over a radio access network. The RF interface circuitry 208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 226 and proceed to filter and amplify (with a low-noise amplifier) the signal. The signal may be provided to a receiver of the transceiver that down-converts the RF signal into a baseband signal that is provided to the baseband processor of the processors 204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 226.

In various embodiments, the RF interface circuitry 208 may be configured to transmit/receive signals in a manner compatible with NR access technologies.

The antenna 226 may include antenna elements to convert electrical signals into radio waves to travel through the air and to convert received radio waves into electrical signals. The antenna elements may be arranged into one or more antenna panels. The antenna 226 may have antenna panels that are omnidirectional, directional, or a combination thereof to enable beamforming and multiple input, multiple output communications. The antenna 226 may include microstrip antennas, printed antennas fabricated on the surface of one or more printed circuit boards, patch antennas, or phased array antennas. The antenna 226 may have one or more panels designed for specific frequency bands including bands in FR1 or FR2.

The user interface 216 includes various input/output (I/O) devices designed to enable user interaction with the UE 200. The user interface 216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 200.

The sensors 220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 222 may include software and hardware elements that operate to control particular devices that are embedded in the UE 200, attached to the UE 200, or otherwise communicatively coupled with the UE 200. The driver circuitry 222 may include individual drivers allowing other components to interact with or control various input/output (I/O) devices that may be present within, or connected to, the UE 200. For example, driver circuitry 222 may include a display driver to control and allow access to a display device, a touchscreen driver to control and allow access to a touchscreen interface, sensor drivers to obtain sensor readings of sensors 220 and control and allow access to sensors 220, drivers to obtain actuator positions of electro-mechanic components or control and allow access to the electro-mechanic components, a camera driver to control and allow access to an embedded image capture device, audio drivers to control and allow access to one or more audio devices.

The PMIC 224 may manage power provided to various components of the UE 200. In particular, with respect to the processors 204, the PMIC 224 may control power-source selection, voltage scaling, battery charging, or DC-to-DC conversion.

A battery 228 may power the UE 200, although in some examples the UE 200 may be mounted deployed in a fixed location and may have a power supply coupled to an electrical grid. The battery 228 may be a lithium ion battery, a metal-air battery, such as a zinc-air battery, an aluminum-air battery, a lithium-air battery, and the like. In some implementations, such as in vehicle-based applications, the battery 228 may be a typical lead-acid automotive battery.

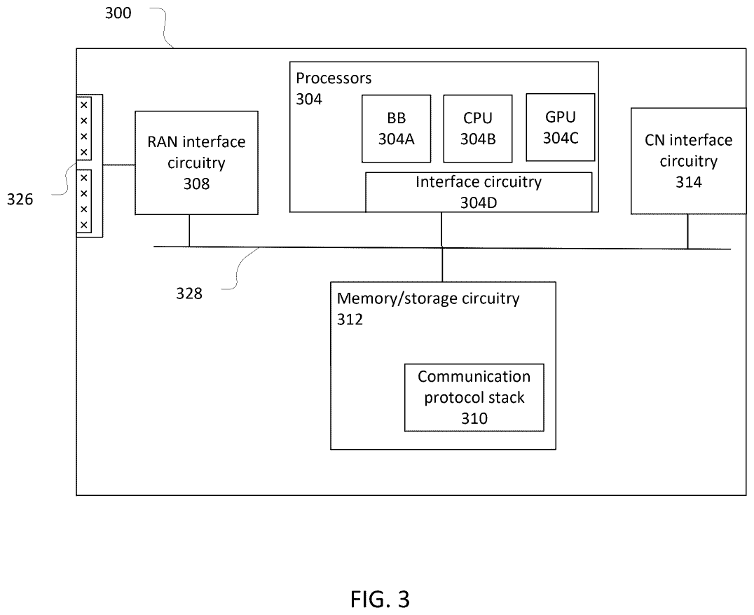

FIG. 3 illustrates a network device 300 in accordance with some embodiments. The network device 300 may be similar to and substantially interchangeable with base station 108 or a device of the core network 112 or external data network 120.

The network device 300 may include processors 304, RF interface circuitry 308 (if implemented as a base station), core network (CN) interface circuitry 314, memory/storage circuitry 312, and antenna structure 326.

The components of the network device 300 may be coupled with various other components over one or more interconnects 328.

The processors 304, RF interface circuitry 308, memory/storage circuitry 312 (including communication protocol stack 310), antenna structure 326, and interconnects 328 may be similar to like-named elements shown and described with respect to FIG. 2.

The processors 304 may include processor circuitry such as, for example, baseband processor circuitry (BB) 304A, central processor unit circuitry (CPU) 304B, and graphics processor unit circuitry (GPU) 304C. The processors 304 may include any type of circuitry or processor circuitry that executes or otherwise operates computer-executable instructions, such as program code, software modules, or functional processes from memory/storage circuitry 312 to cause the network device 300 to perform operations described herein. The processors 304 may also include interface circuitry 304D to communicatively couple the processor circuitry with one or more other components of the network device 300.

The CN interface circuitry 314 may provide connectivity to a core network, for example, a 5^{th} Generation Core network (5GC) using a 5GC-compatible network interface protocol such as carrier Ethernet protocols, or some other suitable protocol. Network connectivity may be provided to/from the network device 300 via a fiber optic or wireless backhaul. The CN interface circuitry 314 may include one or more dedicated processors or FPGAs to communicate using one or more of the aforementioned protocols. In some implementations, the CN interface circuitry 314 may include multiple controllers to provide connectivity to other networks using the same or different protocols.

During cellular connected mode (e.g., radio resource control (RRC) Connected mode), the Cellular Network may assign radio gaps (e.g., Measurement Gaps in fourth generation (4G)/fifth generation (5G)) to the user equipment (UE) during which the UE is able to switch radio frequency (RF) to other frequencies to search & measure neighbor cells. For example, a serving cell may configure a UE to implement a measurements radio gap to perform measurements at one or more different frequencies to search for neighbor cells and/or perform measurements related to the neighbor cells. Accordingly, during these gaps, the downlink (DL)/uplink (UL) data transfer between the UE and the cellular network is interrupted shown in figures below.

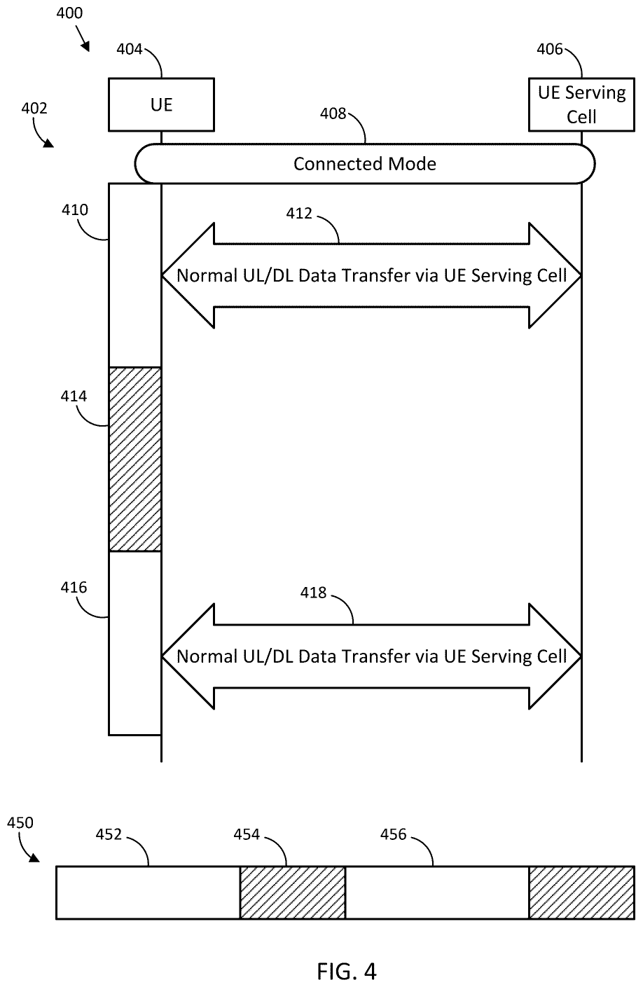

FIG. 4 illustrates example measurements radio gap representations 400 in accordance with some embodiments. For example, the measurements radio gap representations 400 illustrate the implementation of an example measurements radio gap that can be configured between a UE and a serving cell. The measurements radio gap representations 400 illustrate a measurements radio gap implementation in accordance with legacy approaches.

The measurements radio gap representations 400 include a signaling diagram representation 402 and a timing diagram representation 450. The signaling diagram representation 402 and the timing diagram representation 450 both illustrate an example measurements radio gap in accordance with legacy approaches.

The signaling diagram representation 402 include a UE 404. The UE 404 may include one or more of the features of the UE 104 (FIG. 1), the UE 106 (FIG. 1), and/or the UE 200 (FIG. 2). The signaling diagram representation 402 further includes a serving cell 406. The serving cell 406 may be hosted by a base station, such as a nodeB, an evolved nodeB (eNB), or a next generation nodeB (gNB). The base station may include one or more of the features of the base station 108 (FIG. 1), and/or the network device 300 (FIG. 3). The UE 404 is connected to the serving cell 406, as is illustrated by connected mode 408. The serving cell 406 acts as serving cell for the UE 404 while the UE 404 is connected to the serving cell 406.

In the illustrated embodiment, the UE 404 and the serving cell 406 are in a normal operating state 410. The UE 404 and the serving cell 406 may exchange data transfers while in the normal operating state 410. For example, normal UL/DL data transfer 412 via the serving cell 406 may occur during the normal operating state 410.

The UE 404 implements a measurements radio gap instance 414. The UE 404 may be configured to implement the measurements radio gap instance 414 by the serving cell 406. The UE 404 may be assigned to perform measurements for one or more frequencies during the measurements radio gap instance 414. For example, the UE may be assigned for F1 neighbor frequency measurement in the measurements radio gap instance 414 in the illustrated embodiment. Data transfer is interrupted due to performing measurements on F1 during the measurements radio gap instance 414. For example, data transfers between the UE and the serving cells are prevented during the measurements radio gap.

The UE 404 and the serving cell 406 transition to another normal operating state 416 after the measurements radio gap instance 414. The UE 404 and the serving cell 406 may exchange data transfers within in the normal operating state 416. For example, normal UL/DL data transfer 418 via the serving cell 406 may occur during the normal operating state 416.

The timing diagram representation 450 includes a first normal operating state instance 452. Data transfers may occur between the UE and the cellular network while in the first normal operating state instance 452. For example, data transfers may occur between a UE (such as the UE 404) and a serving cell (such as the serving cell 406) during the first normal operating state instance 452.

The timing diagram representation 450 includes a measurements radio gap instance 454 following the first normal operating state instance 452. Data transfer is interrupted in the measurements radio gap instance 454 due to connected mode measurements on neighbor frequencies. For example, data transfers between the UE and the serving cell are prevented during the measurements radio gap instance 454.

The timing diagram representation 450 include a second normal operating state instance 456 following the measurements radio gap instance 454. Data transfers may occur between the UE and the cellular network while in the second normal operating state instance 456. For example, data transfers may occur between the UE and the serving cell during the second normal operating state instance 456.

Issues caused by the DL/UL data transfer interruptions of measurement radio gaps could be considerable in ultra capacities (UCs) like ultra low latency use cases, waiting until measurements radio gaps is ended to resume data transfer could have negative impacts; neighbor cells bands are not supported as part of the UE band combinations; and single radio frequency (RF) devices, where carrier aggregation (CA) is not an option.

A first approach for addressing the UL/DL data transfer interruption caused by measurements radio gaps may include data transfer within measurements radio gap (DTMRG). During a connected mode measurements radio gap, while the UE is performing measurements on a neighbor frequency, the cellular network may exchange data with the UE via one of the neighbor cells that was previously detected and reported by the UE to the cellular network on that neighbor frequency (i.e., neighbor frequency to be measured in the next measurement radio gap instance). This neighbor cell via which data transfer can be exchanged with the UE during measurement radio gap may be referred to as DTMRG Hosting Cell or merely hosting cell. There could be different requirements to be fulfilled to achieve this, like DTMRG hosting cell UE measured power values is within good ranges.

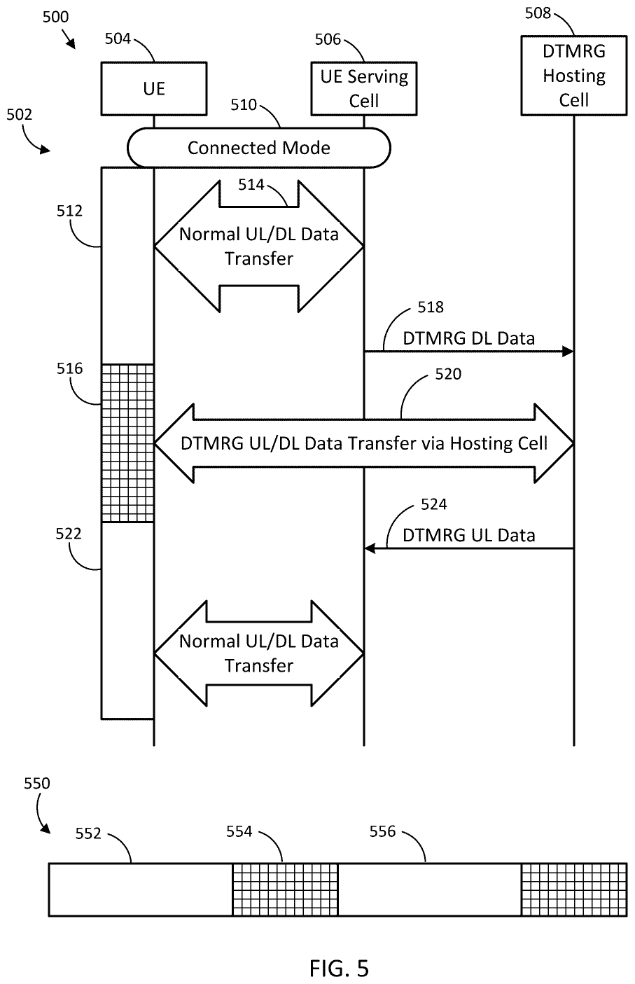

FIG. 5 illustrates example measurements radio gap representations 500 showing DTMRG in accordance with some embodiments. For example, the measurements radio gap representations 500 illustrate measurement radio gaps with DTMRG in accordance with approaches described herein.

The measurements radio gap representations 500 include a signaling diagram 502 and a timing diagram 550. For example, the signaling diagram 502 and the timing diagram 550 show high level representations of DTMRG between elements of a network.

The signaling diagram 502 includes a UE 504. The UE 504 may include one or more of the features of the UE 104 (FIG. 1), the UE 106 (FIG. 1), and/or the UE 200 (FIG. 2). The signaling diagram 502 further includes a serving cell 506 and a hosting cell 508. Each of the serving cell 506 and the hosting cell 508 may be hosted by a base station, such as the base station 108 (FIG. 1), and/or the network device 300 (FIG. 3). The serving cell 506 and the hosting cell 508 may be hosted by a same base station or different base stations. Further, the serving cell 506 and the hosting cell 508 may operate at different frequencies. The serving cell 506 and the hosting cell 508 may be geographically located near each other such that UEs within an area may discover both the serving cell 506 and the hosting cell 508.

The UE 504 may enter a connected mode with the serving cell 506 as illustrated by connected mode 510. The serving cell 506 may operate as a serving cell for the UE 504 while the UE 504 is in the connected mode with the serving cell 506.

The UE 504 may enter a normal operating state 512 while in the connected mode with the serving cell 506. The UE 504 may exchange data with the serving cell 506 while in the normal operating state 512. For example, one or more normal UL/DL data transfers 514 may be exchanged with the UE 504 via the serving cell 506 during the normal operating state 512. The UE 504 and the serving cell 506 may communicate on a first frequency.

The UE 504 may perform one or more measurements on other frequencies to discover other cells within a proximity of the UE 504 operating at different frequencies. The measurements may be performed by the UE 504 in a measurements radio gap. The UE 504 may have discovered the hosting cell 508 while performing the measurements, where the hosting cell 508 is operating at a second frequency that is different than the first frequency of the serving cell 506.

The UE 504 may report that the hosting cell 508 has been discovered to the serving cell 506 and/or provide information related to the hosting cell 508 to the serving cell 506. The serving cell 506 may determine that the hosting cell 508 can be utilized for data transfer within measurements radio gaps. The serving cell 506 may communicate with the hosting cell 508 to configure the hosting cell 508 to exchange data with the UE 504 during measurement radio gaps on behalf of the serving cell 506, as described further throughout this disclosure.

The UE 504 may be configured to implement a measurements radio gap instance 516. In the illustrated embodiment, the serving cell 506 may determine that it has DL data to be transmitted to the UE 504 when the measurements radio gap instance 516 is approaching. The serving cell 506 may determine to utilize the hosting cell 508 to transmit data to the UE 504 during the measurements radio gap instance 516. The serving cell 506 may provide DL data 518 to the hosting cell 508 that is to be transmitted by the hosting cell to the UE 504 during the measurements radio gap instance 516.

The hosting cell 508 may exchange data with the UE 504 during the measurements radio gap instance 516. For example, one or more UL and/or DL data transfers 520 may be exchanged with the UE 504 via the hosting cell 508 during the measurements radio gap instance 516. In the illustrated embodiment, the hosting cell 508 may transmit the DL data 518 to the UE 504 during the measurements radio gap instance 516. Further, the hosting cell 508 may receive UL data from the UE 504 during the measurements radio gap instance 516. The data exchanged between the UE 504 and the hosting cell 508 during the measurements radio gap instance 516 may be exchanged via the second frequency.

The UE 504 may be configured to transition to another normal operating state 522 after the measurements radio gap instance 516. The hosting cell 508 may provide the UL data received from the UE 504 during the measurements radio gap instance 516 to the serving cell 506. For example, the hosting cell 508 may provide UL data 524 to the serving cell 506, where the UL data 524 was received by the hosting cell 508 from the UE 504 during the measurements radio gap instance 516. The hosting cell 508 may provide the UL data 524 to the serving cell 506 during the measurements radio gap instance 516 and/or during the normal operating state 522.

The UE 504 and the serving cell 506 may exchange data while the UE 504 is in the normal operating state 522. For example, one or more normal UL and/or DL data transfers while the UE 504 is in the normal operating state 522.

The timing diagram 550 includes a first normal operating state 552. For example, a UE (such as the UE 504) may be operating in the first normal operating state 552 with a serving cell (such as the serving cell 506). The UE and the serving cell may exchange data during the first normal operating state 552. For example, one or more data transfers may occur between the UE and a cellular network (via the serving cell) during the first normal operating state 552.

The timing diagram 550 includes a measurements radio gap instance 554. For example, the UE may implement the measurements radio gap instance 554. Data exchanges between the UE and the serving cell may be prevented during the measurements radio gap instance 554. However, with the DTMRG approaches described herein, data transfers may be performed within neighbor frequencies measurements radio gaps via one of the detected cells of the neighbor frequency or frequencies to be measured. For example, data transfers may occur between the UE and a hosting cell (such as the hosting cell 508) during the measurements radio gap instance 554. The data transfers performed during the measurements radio gap instance 554 may be performed on behalf of the serving cell. For example, the serving cell may provide data to the hosting cell to be transferred to the UE during the measurements radio gap instance 554 and/or the hosting cell may provide data received from the UE during the measurements radio gap instance 554 to the serving cell.

The timing diagram 550 includes a second normal operating state 556. For example, the UE may enter the second normal operating state 556 after the measurements radio gap instance 554. The UE and the serving cell may exchange data during the second normal operating state 556. For example, one or more data transfers may occur between the UE and the cellular network (via the serving cell) during the second normal operating state 556.

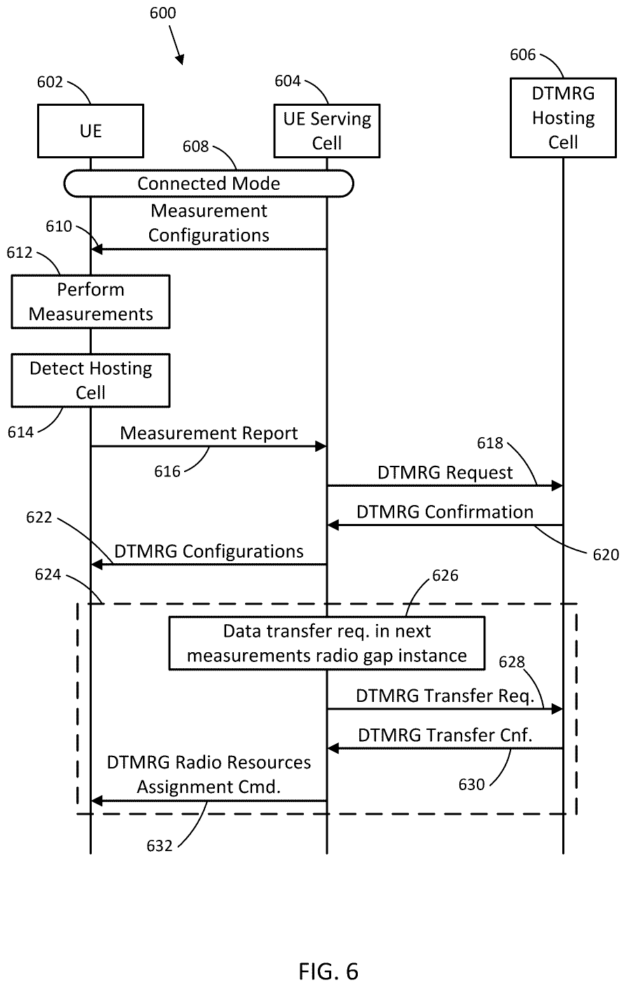

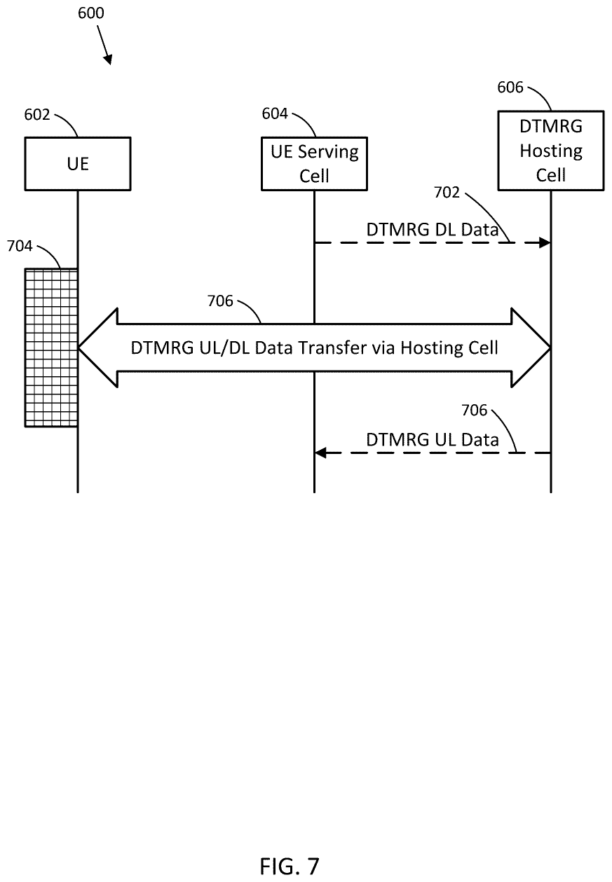

FIG. 6 illustrates a first portion of an example signaling chart 600 showing DTMRG operation in accordance with some embodiments. FIG. 7 illustrates a second portion of the example signaling chart 600 showing DTMRG operation in accordance with some embodiments. For example, the signaling chart 600 illustrates example communications that may be exchanged between elements of a network and operations that may be performed by elements of the network to implement DTMRG approaches described herein.

The signaling chart 600 includes a UE 602. The UE 602 may include one or more of the features of the UE 104 (FIG. 1), the UE 106 (FIG. 1), the UE 200 (FIG. 2), and/or the UE 504 (FIG. 5). The signaling chart 600 further includes a serving cell 604 and a hosting cell 606. Each of the serving cell 604 and the hosting cell 606 may be hosted by a base station, such as the base station 108 (FIG. 1), and/or the network device 300 (FIG. 3). The serving cell 604 and the hosting cell 606 may be hosted by a same base station or different base stations. Further, the serving cell 604 and the hosting cell 606 may operate at different frequencies. The serving cell 604 and the hosting cell 606 may be geographically located near each other such that UEs within an area may discover both the serving cell 604 and the hosting cell 606.

The UE 602 may establish a connection with the serving cell 604. For example, the UE 602 may enter a connected mode 608 with the serving cell 604. The serving cell 604 may operate as a serving cell for the UE 602 while the UE 602 is in the connected mode 608 with the serving cell 604.

The UE 602 may receive connected mode measurement configurations 610 from the network (NW), where frequencies F1/F2/F3 were configured to be measured. For example, the serving cell 604 may provide the one or more measurement configurations 610 to the UE 602, where the measurement configurations 610 may configure the UE 602 to perform measurements on different frequencies. In the illustrated embodiment, the measurement configurations 610 may configure the UE 602 to perform measurements on a first frequency (F1), a second frequency (F2), and a third frequency (F3). The serving cell 604 may transmit one or more radio resource control (RRC) configuration and/or one or more RRC reconfiguration messages to the UE 602 that include the measurement configurations 610. The measurement configurations 610 can indicate the frequencies for which measurements are to be performed and/or measurement gap (MeasGap) configurations.

The UE 602 may start performing measurements 612 according to the received configurations. For example, the UE 602 may perform measurements 612 on the F1, F2, and F3 in accordance with the measurement configurations 610. The UE 602 may perform the measurements 612 during a measurements radio gap instance configured by the measurement configurations 610. In some embodiments, the measurements radio gap instance can be configured by the MeasGap configurations included in the measurement configurations 610. The UE 602 may detect the hosting cell 606 based on the performed measurements 612, as indicated by the detect hosting cell 614. For example, the UE 602 may detect the hosting cell 606 on the F1 in the illustrated embodiment.

The UE 602 may report to the NW one of the detected cells, the hosting cell 606, on the neighbor frequency F1. For example, the UE 602 may generate a measurement report 616 for transmission to the serving cell 604. The measurement report 616 may be a layer 1 (L1) or a layer 3 (L3) measurement report. The measurement report 616 may indicate that the UE 602 detected the hosting cell 606 on the F1. The serving cell 604 may identify the measurement report 616 received from the UE 602 and may determine that the UE 602 detected the hosting cell 606 on the F1.

The NW may decide that data transfer can be exchanged with the UE 602 via the hosting cell 606, acting as DTMRG Hosting Cell, during the radio gaps assigned for F1 neighbor frequency measurements. For example, the serving cell 604 (or a core network element coupled with the serving cell 604) may determine that the serving cell 604 can exchange data with the UE 602 via the hosting cell 606 during measurement radio gaps that are configured for performance of measurements on the F1. The NW decision could be based on various parameters, such as the amount of data pending transfer for the UE 602, the hosting cell 606 power (PWR) values, and/or other parameters related to the UE 602 and/or the hosting cell 606. For example, the serving cell 604 (or a core network element) may determine that the serving cell 604 can be utilized for exchanging data with the UE 602 based on one or more of the parameters.

NW radio access network (RAN)-base station (BS)1 (i.e., a BS hosting the serving cell 604), serving the UE 602, may request from RAN-BS of the hosting cell 606 (RAN-BS2, i.e., a BS hosting the hosting cell 606) to exchange data with the UE 602 via the hosting cell 606, within a certain period that corresponds to the radio gaps that will be assigned for F1 measurements. For example, the serving cell 604 may generate and/or transmit a data transfer measurements radio gaps request 618 to the hosting cell 606. The data transfer measurements radio gaps request 618 may request that the hosting cell 606 support the serving cell 604 in exchanging data with the UE 602 via the hosting cell 606 during measurements radio gap instances via the F1. Provided information may include the UE 602 physical ID, the UE 602 measurements for the hosting cell 606, based on data received from UE 602 in the Measurement Report, and/or the UE 602 measurement pattern for the hosting cell's frequency. For example, data transfer measurements radio gaps request 618 transmitted from the serving cell 604 to the hosting cell 606 may include the information.

RAN-BS2 may prepare the configurations required for exchanging data between the UE 602 and the hosting cell 606 during the requested period that corresponds to radio gaps assigned for F1 measurement by the UE 602. For example, the serving cell 604 may generate and/or transmit a data transfer within measurement radio gaps confirmation 620 to the serving cell 604. The data transfer within measurement radio gaps confirmation 620 may include configurations required for exchanging data between the UE 602 and the hosting cell 606 during measurements radio gaps. The configurations could be like a UE identity that shall be used while operating on the hosting cell 606, e.g., a new measurement gap (MG)-radio network temporary identifier (RNTI) to be used during data transfer via the hosting cell 606, and/or a hosting cell physical layer configuration required to be able to perform data transfer. The hosting cell physical layer configuration may include information like hosting cell beam identifier (BeamID) that shall be used (e.g., in case there are multi-beams reported, then hosting cell 606 may choose the one to serve the UE 602, example based on beams load).

The RAN-BS1 may provide back to the UE 602 the configuration required to exchange data via the hosting cell 606 during measurement gaps assigned for F1. For example, the serving cell 604 may generate and/or transmit one or more DTMRG configurations 622 that can be used to exchange data via the hosting cell 606 during measurements radio gaps assigned for the F1. The DTMRG configurations 622 may be included in one or more RRC reconfiguration messages. The DTMRG configurations 622 may optionally include the pattern of measurement gaps instances that the UE 602 should use for measuring F1.

Before the measurement gaps instances that shall be used by the UE 602 for measuring F1, RAN-BS1 may perform one or more of the following operations. For example, the serving cell 604 (and/or the base station hosting the serving cell 604) may perform one or more of 626, 628, 630, 632, and/or 702. Box 624 illustrates operations that may be optional. For example, 626, 628, 630, and 632 within box 624 may be optional. The operations within box 624 may be performed if all information required for exchanging data via the hosting cell 606 is not pre-configured/semi-static. If the information required for exchanging data via the hosting cell 606 is preconfigured and/or semi-static, the operations within the box 624 may be skipped.

The serving cell 604 may determine that a data transfer is to be performed and/or is required in a next measurement radio gap instance for the UE 602 via the hosting cell 606 in 626.

Before the measurement gaps instances that shall be used by the UE 602 for measuring F1, RAN-BS1 may indicate to RAN-BS2 that in the next measurement gap instance, data transfer with the UE 602 via the hosting cell 606 should take place. For example, the serving cell 604 may generate and/or transmit a DTMRG transfer request 628 to the hosting cell 606 prior to one or more measurements radio gap instances to be utilized for data exchange via the hosting cell 606. The DTMRG transfer request 628 may indicate that a next measurement gap instance is to be utilized for communication via the hosting cell 606. RAN-BS1 may provide to RAN-BS2 information like an amount of UL/DL data required to be transferred, the latest UE's 602 hosting cell measurements (e.g., PWR measurements) values, and/or measurement radio gap start time and duration, if not previously provided. For example, the DTMRG transfer request 628 may include one or more of an identifier (ID) of the UE 602, radio gap instance information (such as a start time and/or duration of a measurements radio gap), an amount of UL/DL data to be transferred, and/or a latest power measurement of the UE 602 for the hosting cell 606.

RAN-BS2 may confirms back to RAN-BS1 and may provide information back to RAN-BS1 like an amount of UL/DL bytes that could be exchanged with UE 602 and/or, optionally, the UL/DL grant information. The amount of UL/DL bytes that could be exchanged with UE 602 could be based on hosting cell radio resources availability within the next DTMRG instance. The UL/DL grant information may be applicable if this information was not already pre-configured as part of 620 or if the UE 602 is not required to listen for grants on the hosting cell 606 (e.g., in 4G/5G, the UE 602 is not required to listen to physical downlink control channel (PDCCH) on the hosting cell 606.) For example, the hosting cell 606 may generate and/or transmit a DTMRG transfer confirmation 630 to the serving cell 604. The DTMRG transfer confirmation 630 may indicate that the hosting cell 606 accepts the DTMRG transfer request 628. The DTMRG transfer confirmation 630 may include an indication of an amount of UL/DL bytes allocated for the requested data transfer and/or UL/DL grant information for the requested data transfer.

RAN-BS1 may provide the UE 602 information about the assignment of data exchange with the hosting cell 606 in the next Measurement Gap instance, which could be via one or more messages (e.g., 4G/5G L1 downlink control information (DCI) messages). The information could be like indicating that next measurement radio gap instance shall be assigned for frequency F1 measurements in case the measurement pattern for F1 was not pre-configured, and/or the radio sources information via which the UE 602 can transmit/receive data via the hosting cell 606. For example, the serving cell 604 may generate and/or transmit a DTMRG radio resources assignment command 632 for transmission to the UE 602. The DTMRG radio resources assignment command 632 may be transmitted in one or more messages. The DTMRG radio resources assignment command 632 may include information about the assignment of data exchange with the hosting cell 606 for the UE 602 in the next measurement radio gap. The DTMRG radio resources assignment command 632 may indicate that a next measurements radio gap instance is to be assigned for F1 measurements and/or may include radio sources information for data exchange between the UE 602 and the hosting cell 606 during the next measurements radio gap instance. The DTMRG radio resources assignment command 632 may be transmitted via one or more L1 DCI messages.

RAN-BS1 may provide RAN-BS2 the DL data to be transferred to UE 602, if DL data was planned for this DTMRG gap instance. For example, the serving cell 604 may generate and/or transmit DTMRG DL data 702 to the hosting cell 606 prior to a next measurements radio gap if the DTMRG DL data 702 is to be transmitted to the UE 602 in the next measurements radio gap. In some embodiments the serving cell 604 may generate one or more DL payloads that include the DTMRG DL data 702 to be transmitted in the next measurements radio gap. In instances where DL data is not to be transmitted to the UE 602 in the next measurements radio gap instance, the DTMRG DL data 702 generation and/or transmission may be omitted.

The UE 602 may implement a measurements radio gap instance 704. The measurements radio gap instance 704 may be assigned for DTMRG on the F1. UL/DL data may be exchanged between the UE 602 and the hosting cell 606 during the measurements radio gap instance 704. For example, one or more DTMRG UL/DL data transfers 706 may be exchanged with the UE 602 via the hosting cell 606 during the measurements radio gap instance 704. In instances where DTMRG DL data 702 has been provided to the hosting cell, the DTMRG UL/DL data transfers may include the DTMRG DL data 702. In some instances, the UE 602 may also perform measurements on the F1.

RAN-BS2 may provide RAN-BS1 the received UE's UL data, if UL data was planned for this DTMRG gap instance. For example, the hosting cell 606 may receive UL data from the UE 602 in the DTMRG UL/DL data transfers 706 in some instances. The hosting cell 606 may transmit DTMRG UL data 708 received from the UE 602 to the serving cell 604. The hosting cell 606 may generate and/or transmit one or more UL payloads with the DTMRG UL data 708 to the serving cell 604. In instances where the hosting cell 606 does not receive data from the UE 602 in the DTMRG UL/DL data transfers 706, the DTMRG UL data 708 may be omitted.

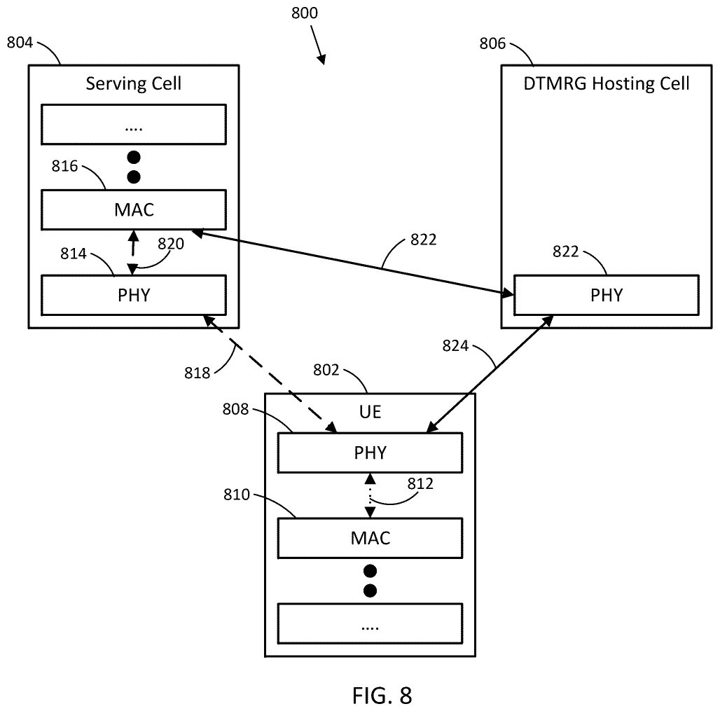

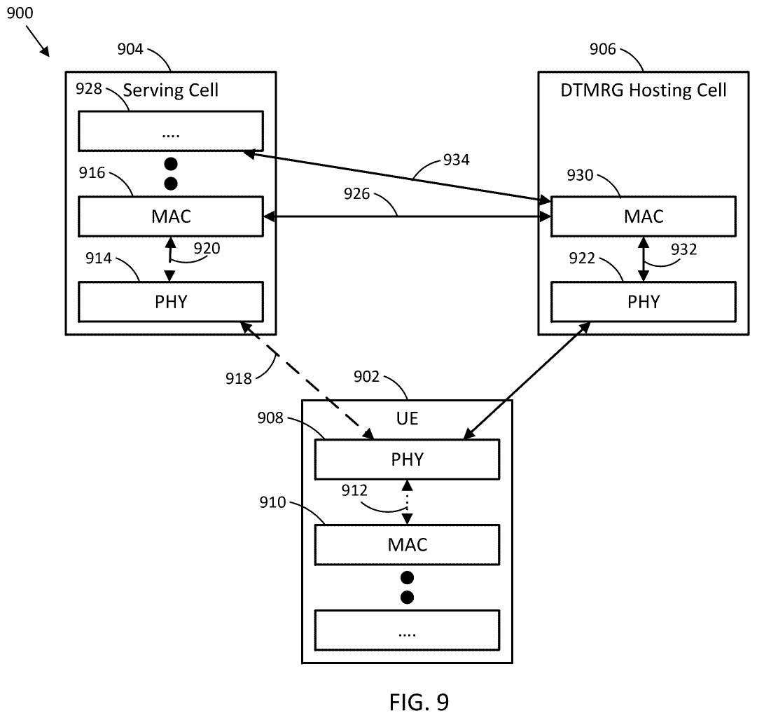

FIG. 8 illustrates an example DTMRG architecture 800 in accordance with some embodiments. There could be different data flow architectures that could be applied for DTMRG, like the one shown in FIG. 8, based on location of data split. FIG. 9 illustrates another example DTMRG architecture 900 in accordance with some embodiments.

The DTMRG architecture 800 includes a UE 802. The UE 802 may include one or more of the features of the UE 602 (FIG. 6). The DTMRG architecture 800 further includes a serving cell 804. The serving cell 804 may include one or more of the serving cell 604 (FIG. 6). The DTMRG architecture 800 further includes a hosting cell 806. The hosting cell 806 may include one or more of the features of the hosting cell 606 (FIG. 6). The UE 802 may be in a connected mode with the serving cell 804 and the hosting cell 806 may be configured for DTMRG with the UE 802 during one or more measurements radio gaps.

The DTMRG architecture 800 illustrates flows of data among the UE 802, the serving cell 804, and the hosting cell 806. For example, the DTMRG architecture 800 includes solid lines illustrating data flow of data exchanged during measurements radio gaps, dashed lines illustrating data flow of data exchanged during normal operating states, and dotted lines illustrating data flow that includes both data exchanged during measurements radio gaps and data exchanged during normal operating states.

The UE 802 may include a physical layer (PHY) entity 808 and a MAC entity 810. Data exchanged during the measurements radio gaps and data exchanged during the normal operating states may be exchanged between the PHY entity 808 and the MAC entity 810, as illustrated by dotted line 812.

The serving cell 804 may include a PHY entity 814 and a MAC entity 816. Data exchanged between the serving cell 804 and the UE 802 during the normal operating states may be exchanged between the PHY entity 808 of the UE 802 and the PHY entity 814 of the serving cell 804, as illustrated by dashed line 818. The data exchanged during the normal operating states may further be exchanged between the PHY entity 814 and the MAC entity 816, as illustrated by dashed line 820.

The hosting cell 806 may include a PHY entity 822. Data exchanged between the hosting cell 806 and the UE 802 during the measurements radio gaps may be exchanged between the PHY entity 808 of the UE 802 and the PHY entity 822 of the hosting cell 806, as illustrated by the solid line 824. The data exchanged between the serving cell 804 and the hosting cell 806 (which may include the data to be transmitted to the UE 802 during the measurements radio gaps and/or the data received from the UE 802 during the measurements radio gaps) may be exchanged between the PHY entity 822 of the hosting cell 806 and the MAC entity 816 of the serving cell 804, as illustrated by the solid line 826.

The DTMRG architecture 900 includes a UE 902. The UE 902 may include one or more of the features of the UE 602 (FIG. 6). The DTMRG architecture 900 further includes a serving cell 904. The serving cell 904 may include one or more of the serving cell 604 (FIG. 6). The DTMRG architecture 900 further includes a hosting cell 906. The hosting cell 906 may include one or more of the features of the hosting cell 606 (FIG. 6). The UE 902 may be in a connected mode with the serving cell 904 and the hosting cell 906 may be configured for DTMRG with the UE 902 during one or more measurements radio gaps.

The DTMRG architecture 900 illustrates flows of data among the UE 902, the serving cell 904, and the hosting cell 906. For example, the DTMRG architecture 900 includes solid lines illustrating data flow of data exchanged during measurements radio gaps, dashed lines illustrating data flow of data exchanged during normal operating states, and dotted lines illustrating data flow that includes both data exchanged during measurements radio gaps and data exchanged during normal operating states.

The UE 902 may include a physical layer (PHY) entity 908 and a MAC entity 910. Data exchanged during the measurements radio gaps and data exchanged during the normal operating states may be exchanged between the PHY entity 908 and the MAC entity 910, as illustrated by dotted line 912.

The serving cell 904 may include a PHY entity 914 and a MAC entity 916. Data exchanged between the serving cell 904 and the UE 902 during the normal operating states may be exchanged between the PHY entity 908 of the UE 902 and the PHY entity 914 of the serving cell 904, as illustrated by dashed line 918. The data exchanged during the normal operating states may further be exchanged between the PHY entity 914 and the MAC entity 916, as illustrated by dashed line 920. The serving cell 904 may further include one or more higher layers 928.

The hosting cell 906 may include a PHY entity 922 and a MAC entity. Data exchanged between the hosting cell 906 and the UE 902 during the measurements radio gaps may be exchanged between the PHY entity 908 of the UE 902 and the PHY entity 922 of the hosting cell 906, as illustrated by the solid line 924. Further, the data exchanged during the measurements radio gaps may be exchanged between the PHY entity 922 and the MAC entity 930, as illustrated by the solid line 932. The data exchanged between the serving cell 904 and the hosting cell 906 (which may include the data to be transmitted to the UE 902 during the measurements radio gaps and/or the data received from the UE 902 during the measurements radio gaps) may be exchanged between the MAC entity 930 of the hosting cell 906 and the MAC entity 916 of the serving cell 904 in some embodiments, as illustrated by the solid line 926. In other embodiments, the data exchanged between the serving cell 904 and the hosting cell 906 may be exchanged between the MAC entity 930 of the hosting cell 906 and one or more of the higher layers 928 of the serving cell 904, as illustrated by solid line 934.

There may be different options for a medium access control (MAC) entity serving DTMRG data. In a first option (which may be referred to as “option #1”), a single MAC-entity, the serving cell MAC entity, may be used to serve the UE within and outside the DTMRG instances. The first option may be as shown in the DTMRG architecture 800. For example, the MAC entity 816 may be used to serve the UE 802 both within and outside of measurements radio gap instances. In particular, the data transfers between the serving cell 804 and the UE 802 during the normal operating states and the data transfers between the UE 802 and the hosting cell 806 during the measurements radio gap instances may be exchanged and/or processed by the MAC entity 816 of the serving cell 804. Information about HARQ entity to be used and its corresponding information (e.g., 4G/5G redundancy version (RV), NDI, . . . ) may be provided by the serving cell 804 to the DTMRG Hosting Cell 806 for each scheduled data transfer to the UE 802 within the DTMRG gap. All MAC protocol data units (PDUs), transmitted and/or received within DTMRG (e.g., within measurement radio gaps), may be generated and/or processed by the MAC entity 816 of the serving cell 804.

In a second option (which may be referred to as “option #2:), multiple MAC-entities may be used to serve the UE, where there is a dedicated MAC-entity in DTMRG Hosting Cell for serving the UE data within DTMRG. For example, the second option may be as shown in the DTMRG architecture 900. The MAC entity 916 of the serving cell 904 may be utilized for generating and/or processing of MAC PDUs transmitted and/or received during the normal operating state. The MAC entity 930 of the hosting cell may be utilized for generating and/or processing of MAC PDUs transmitted and/or received within DTMRG (e.g., within measurement radio gaps), may be generated and/or processed by the MAC entity 930 of the hosting cell 906.

There may be different options for hybrid automatic repeat request (HARQ) entities, in case of the single MAC-entity option (the first option of the MAC entity). In a first option (which may be referred to as “Option #1”) for the HARQ entities, shared HARQ entities across serving and DTMRG Hosting Cell(s). As an example, a HARQ entity may be used for a new payload transmission within DTMRG via the hosting cell 906, could be scheduled for re-transmissions on serving cell and vise versa. In a second option (which may be referred to as “Option #2”) for the HARQ entities, a dedicated HARQ entity may be used for DTMRG data transfer via the DTMRG hosting cell 906.

There may be multiple options for HARQ feedbacks for DTMRG. In a first option (which may be referred to as “option #1”), HARQ feedback for data payload transferred within DTMRG could be provided after DTMRG via serving cell, same for vise versa. For example, HARQ feedback for data payload could be transferred within the same DTMRG as the data payload is exchanged, could be provided after the DTMRG where data payload is exchanged via serving cell, and/or could be provided in a DTMRG after the data payload is exchanged outside of the DTMRG.

In a second option (which may be referred to as “option #2”), HARQ feedback could be skipped. And data payload may be transmitted multiple times after each other with different redundancy versions, similar to transmission time interval (TTI) bundling in long term evolution (LTE) and Slot Aggregation in 5G.

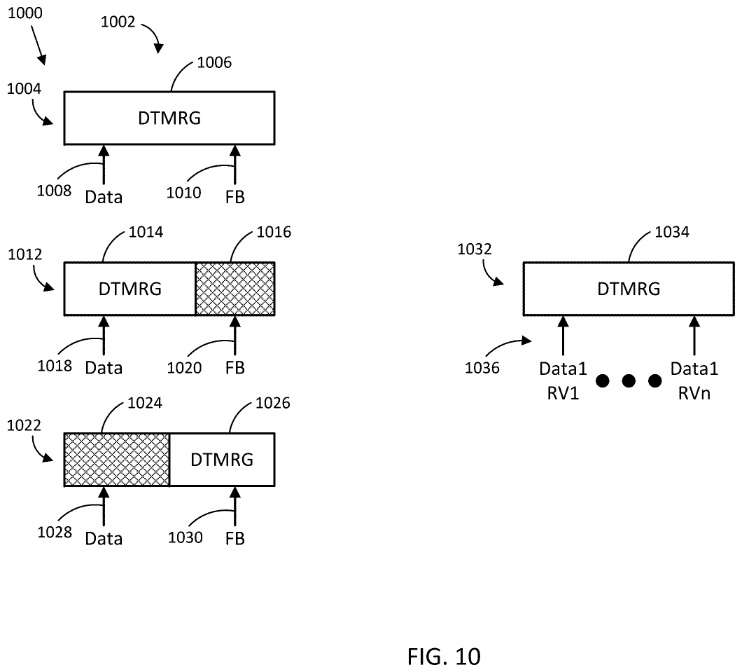

FIG. 10 illustrates example option representations 1000 for HARQ feedback in accordance with some embodiments. In particular, the option representations 1000 illustrate examples of the first option and the second option for HARQ feedbacks described above.

The option representations 1000 include first option representations 1002. The first option representations 1002 illustrate HARQ feedback examples in accordance with the first option. A first representation 1004 illustrates an example where HARQ feedback is provided in a same measurements radio gap instance as the payload data is exchanged. For example, the first representation 1004 includes a measurements radio gap instance 1006. Data 1008 may be exchanged in the measurements radio gap instance 1006. HARQ feedback 1010 for the data 1008 may be provided in the measurements radio gap instance 1006.

A second representation 1012 illustrates an example where HARQ feedback is provided in a normal operating state after the measurements radio gap instance where the payload data is exchanged. For example, the second representation 1012 includes a measurements radio gap instance 1014 and a normal operating state 1016 following the measurements radio gap instance 1014. Data 1018 may be exchanged in the measurements radio gap instance 1014. HARQ feedback 1020 for the data 1018 may be provided in the normal operating state 1016.

A third representation 1022 illustrates an example where HARQ feedback is provided in a measurements radio gap instance after a normal operating state where the payload data is exchanged. For example, the third representation 1022 includes a normal operating state 1024 and a measurements radio gap instance 1026 following the normal operating state 1024. Data 1028 may be exchanged in the normal operating state 1024. HARQ feedback 1030 for the data 1028 may be provided in the measurements radio gap instance 1026.

The option representations 1000 include a second option representation 1032. The second option representation 1032 illustrates HARQ feedback examples in accordance with the second option. For example, the second option representation 1032 includes a measurements radio gap instance 1034. One or more data payload repetitions 1036 may be exchanged during the measurements radio gap instance 1034, where each of the data payload repetitions 1036 may have different redundancy versions.

There may be multiple schemes for DTMRG gaps assignments alignment. The measurement radio gaps during which the UE exchanges data with Cellular Network via the DTMRG Hosting Cell may be aligned between the UE and the Cellular Network. This can be achieved by different schemes.

In a first scheme (which may be referred to as “Scheme #1”), semi-static assignment may be implemented. Cellular NW may configure the UE with the measurement radio gaps pattern where the UE may measure DTMRG hosting cell's frequency & exchange data transfer with cellular network via the DTMRG hosting cell. Optionally, the UE may purpose to the cellular NW certain measurement radio gaps pattern for the DTMRG hosting Cell's frequency. As an example, the measurement radio gaps pattern may be provided via L3 signaling air-message, like measurement reports for DTMRG Hosting Cell's frequency, and/or via UE assistant information.

In a second scheme (which may be referred to as “Scheme #2”), dynamic assignment may be implemented. For the measurement radio gap instances, the Cellular NW may require an exchange of data with the UE via the DTMRG hosting cell, the Cellular NW may send command to the UE indicating that the next measurement radio gap instance shall be used for measuring DTMRG Hosting Cell's frequency. Cellular NW command could be as simple as L1 command (CMD) (e.g., via DCI message), or even via UL/DL grant having radio resources allocation within the next instance of the measurements radio gap. CMD may include information about the DTMRG configuration ID that shall be applied, incase the UE was configured with more than DTMRG Hosting Cell configuration.

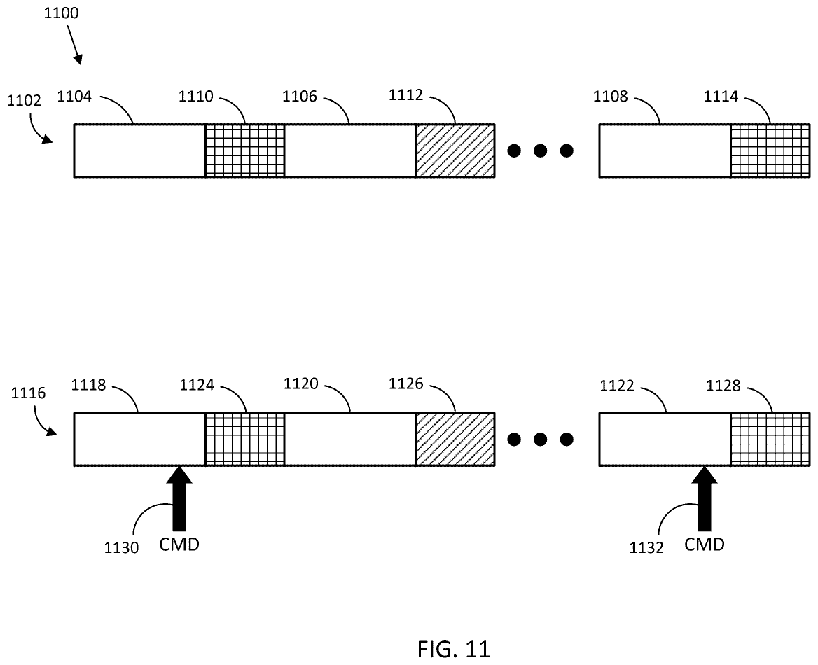

FIG. 11 illustrates an example DTMRG gaps assignments alignment representations 1100 in accordance with some embodiments. For example, the DTMRG gaps assignments alignment representations 1100 illustrates timing diagrams for the first scheme and the second scheme described above.

The DTMRG gaps assignments alignment representations 1100 includes a first scheme representation 1102. The first scheme representation 1102 illustrates UE radio activities in accordance with the first scheme. For example, the first scheme representation 1102 may illustrate radio activities of a UE, such as the UE 104 (FIG. 1), the UE 106 (FIG. 1), the UE 200 (FIG. 2), the UE 504 (FIG. 5), the UE 602 (FIG. 6), the UE 802 (FIG. 8), and/or the UE 902 (FIG. 9). In the first scheme representation 1102, the UE may be pre-configured with which measurements radio gaps are to be utilized for exchanging data with a hosting cell.

The first scheme representation 1102 may include a first normal operating state instance 1104, a second normal operating instance 1106, and a third normal operating state instance 1108. Data transfer between the UE and cellular network via a serving cell (such as the serving cell 506 (FIG. 5), the serving cell 604 (FIG. 6), the serving cell 804 (FIG. 8), and/or the serving cell 904 (FIG. 9)) of the UE may be performed during the normal operating instances.

The first scheme representation 1102 may further include a first measurements radio gap 1110, a second measurements radio gap 1112, and a third measurements radio gap 1114. The UE may be pre-configured to utilize one or more of the measurements radio gaps for data transfers via a hosting cell (such as the hosting cell 508 (FIG. 5), the hosting cell 606 (FIG. 6), the hosting cell 806 (FIG. 8) and/or the hosting cell 906 (FIG. 9)) of the UE. In the illustrated embodiment, the UE may be pre-configured for data transfers within the first measurements radio gap 1110 and the third measurements radio gap 1114. Accordingly, data transfer between the UE and cellular network via the DTMRG hosting cell, and measurements on the frequency of the hosting cell may be performed during the first measurements radio gap 1110 and the third measurements radio gap 1114. In the illustrated embodiment, the second measurements radio gap 1112 may not be pre-configured for data transfers and the UE may perform measurements on a connected mode neighbor frequency.

The DTMRG gaps assignments alignment representations 1100 includes a second scheme representation 1116. The second scheme representation 1116 illustrates UE radio activities in accordance with the second scheme. For example, the second scheme representation 1116 may illustrate radio activities of a UE, such as the UE 104 (FIG. 1), the UE 106 (FIG. 1), the UE 200 (FIG. 2), the UE 504 (FIG. 5), the UE 602 (FIG. 6), the UE 802 (FIG. 8), and/or the UE 902 (FIG. 9). In the second scheme representation 1116, the UE may be dynamically configured via a command with which measurements radio gaps are to be utilized for exchanging data with a hosting cell.

The second scheme representation 1116 may include a first normal operating state instance 1118, a second normal operating instance 1120, and a third normal operating state instance 1122. Data transfer between the UE and cellular network via a serving cell (such as the serving cell 506 (FIG. 5), the serving cell 604 (FIG. 6), the serving cell 804 (FIG. 8), and/or the serving cell 904 (FIG. 9)) of the UE may be performed during the normal operating instances.

The first scheme representation 1102 may further include a first measurements radio gap 1124, a second measurements radio gap 1126, and a third measurements radio gap 1128. The UE may receive commands from the serving cell indicating which measurements radio gaps are to be utilized for exchanging data with a hosting cell (such as the hosting cell 508 (FIG. 5), the hosting cell 606 (FIG. 6), the hosting cell 806 (FIG. 8), and/or the hosting cell 906 (FIG. 9)). In the illustrated embodiment, the UE may receive a first command 1130 indicating that the first measurements radio gap 1124 is to be utilized for exchanging data with the hosting cell and a second command 1132 indicating that the third measurements radio gap 1128 is to be utilized for exchanging data with the hosting cell. The first command 1130 and the second command 1132 may be received from the serving cell and may indicate to use a next measurement radio gap instance for DTMRG. Data transfer between the UE and cellular network via DTMRG hosting cell and performing measurements of the frequency of the hosting cell may be performed in the first measurements radio gap 1124 and the third measurements radio gap 1128 based at least in part on the first command 1130 and the second command 1132. The second measurements radio gap 1126 may perform measurements on a connected mode neighbor frequency based at least in part on a corresponding command not being received for the second measurements radio gap 1126. The second measurements radio gap 1126 may be utilized by the UE to measure other neighbor frequency other than DTMRC hosting cell's frequency.

There may be one or more DTMRG radio resources assignments schemes. The radio resources assignments (UL/DL grants) required by the UE to transmit/receive data with Cellular Network in the DTMRG via the DTMRG hosting cell could be provided to the UE via different schemes.

In a first scheme (which may be referred to as “Scheme #1”), pre-configuration may be implemented. Cellular NW may configure the UE with a semi-static radio resources assignment, example via L3 signaling air-message (e.g., RRC Reconfiguration air-message), that shall be applied by the UE during measurement radio gaps assigned for DTMRG operations.

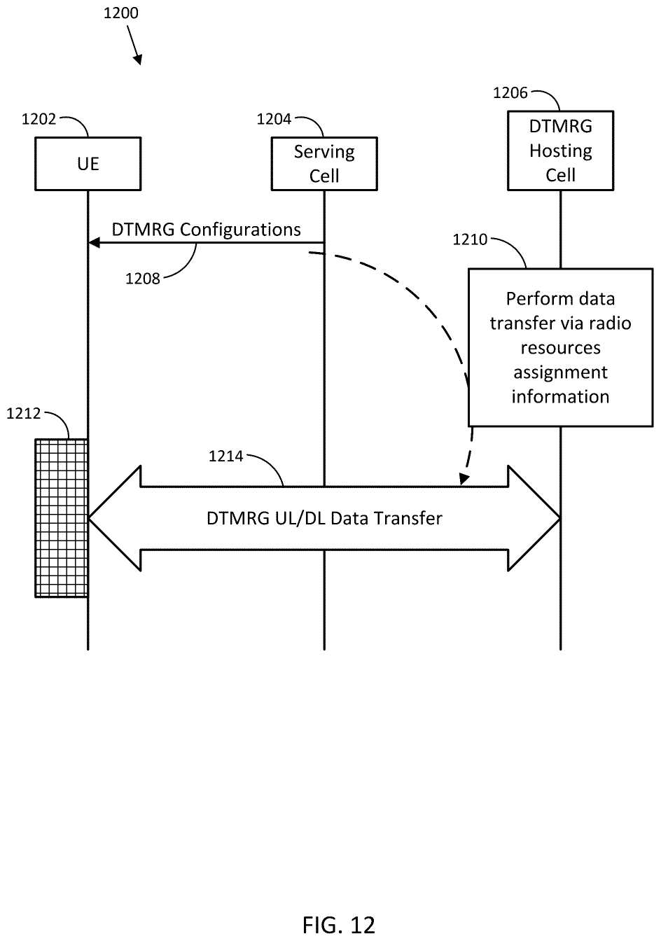

FIG. 12 illustrates an example signaling chart 1200 implementing the first scheme in accordance with some embodiments. For example, the signaling chart 1200 illustrates signals that may be exchanged and operations that may be performed as part of the first scheme for DTMRG radio resources assignments.

The signaling chart 1200 includes a UE 1202. The UE 1202 may include one or more of the features of the UE 104 (FIG. 1), the UE 106 (FIG. 1), the UE 200 (FIG. 2), the UE 504 (FIG. 5), the UE 602 (FIG. 6), the UE 802 (FIG. 8), and/or the UE 902 (FIG. 9). The signaling chart 1200 further includes a serving cell 1204 and a hosting cell 1206. The serving cell 1204 may include one or more of the features of the serving cell 506 (FIG. 5), the serving cell 604 (FIG. 6), the serving cell 804 (FIG. 8), and/or the serving cell 904 (FIG. 9). The hosting cell 1206 may include one or more of the features of the hosting cell 508 (FIG. 5), the hosting cell 606 (FIG. 6), the hosting cell 806 (FIG. 8), and/or the hosting cell 906 (FIG. 9).

The serving cell 1204 may generate and/or transmit one or more DTMRG configurations 1208 to the UE 1202. For example, the serving cell 1204 may generate and/or transmit one or more L3 or RRC reconfiguration messages to the UE 1202 that include the DTMRG configurations 1208. The DTMRG configurations 1208 may include radio resources assignment information for exchanging data with the hosting cell 1206 during one or more measurement radio gap instances. The hosting cell 1206 may be configured for performing data transfer via radio resources assignment received via DTMRG feature configurations, as illustrated by 1210.

The UE 1202 may implement a measurements radio gap instance 1212. The measurements radio gap instance may be assigned to DTMRG as described throughout this disclosure. The UE 1202 may perform a DTMRG UL/DL data transfer 1214 via the hosting cell 1206 using the radio resource assignments provided by the radio resources assignment information received in the DTMRG configurations 1208.

In a second scheme (which may be referred to as “Scheme #2”), via serving cell command may be implemented. Before the measurement radio gap the cellular NW require using for DTMRG with the UE, the cellular NW may provide the UE with the radio resources assignment(s), example via L1 CMD (e.g., DCI message), that the UE shall apply during the next measurement radio gap assigned for DTMRG. The radio resources assignment information could be received by the serving cell from the DTMRG Hosting cell.

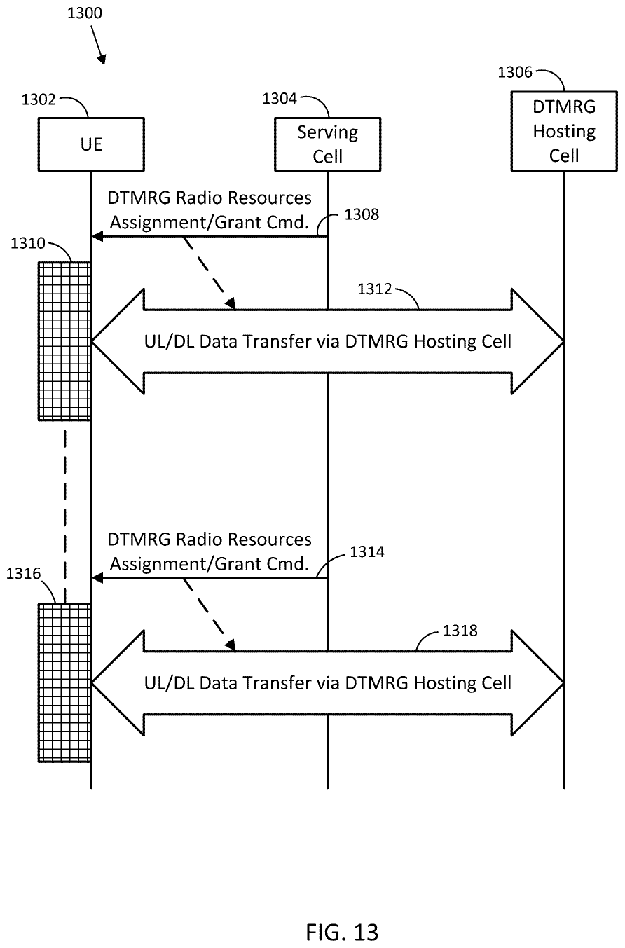

FIG. 13 illustrates an example signaling chart 1300 implementing the second scheme in accordance with some embodiments. For example, the signaling chart 1300 illustrates signals that may be exchanged and operations that may be performed as part of the second scheme for DTMRG radio resources assignments.

The signaling chart 1300 includes a UE 1302. The UE 1302 may include one or more of the features of the UE 104 (FIG. 1), the UE 106 (FIG. 1), the UE 200 (FIG. 2), the UE 504 (FIG. 5), the UE 602 (FIG. 6), the UE 802 (FIG. 8), the UE 902 (FIG. 9), and/or the UE 1202 (FIG. 12). The signaling chart 1300 further includes a serving cell 1304 and a hosting cell 1306. The serving cell 1304 may include one or more of the features of the serving cell 506 (FIG. 5), the serving cell 604 (FIG. 6), the serving cell 804 (FIG. 8), the serving cell 904 (FIG. 9), and/or the serving cell 1204 (FIG. 12). The hosting cell 1306 may include one or more of the features of the hosting cell 508 (FIG. 5), the hosting cell 606 (FIG. 6), the hosting cell 806 (FIG. 8), the hosting cell 906 (FIG. 9), and/or the hosting cell 1206 (FIG. 12).

The serving cell 1304 may provide DTMRG radio resources assignment/grant commands to the UE 1302, where the DTMRG radio resources assignment/grant commands provide radio resources assignment information for a next measurements radio gap. For example, the serving cell 1304 may generate and/or transmit a first DTMRG radio resources assignment/grant command 1308. The first DTMRG radio resources assignment/grant command 1308 may include radio resources assignment information for a first measurements radio gap instance 1310. The UE 1302 may identify the first DTMRG radio resources assignment/grant command 1308 and utilize the radio resources assignment information for one or more UL/DL data transfers 1312 via the hosting cell 1306 during the first measurements radio gap instance 1310.

Further, the serving cell 1304 may generate and/or transmit a second DTMRG radio resources assignment/grant command 1314. The second DTMRG radio resources assignment/grant command 1314 may include radio resources assignment information for a second measurements radio gap instance 1316. The UE 1302 may identify the second DTMRG radio resources assignment/grant command 1314 and utilize the radio resources assignment information for one or more UL/DL data transfers 1318 via the hosting cell 1306 during the second measurements radio gap instance 1316.

In a third scheme (which may be referred to as “scheme #3”), via DTMRG hosting cell DTMRG radio resources assignments may be implemented. Within the measurement radio gaps assigned for DTMRG, the UE may receive the radio resources assignment(s) command(s) (e.g., UL/DL grants) directly from the DTMRG hosting cell. As an example, the resources assignments commands may be via one of the DTMRG hosting cell's common physical channels like physical downlink control channel (PDCCH), or even within a dedicated radio resources (e.g., dedicated search space for radio assignments) that are pre-configured to the UE, example via layer 2 (L2) signaling air-messages, during the DTMRG feature enablement.

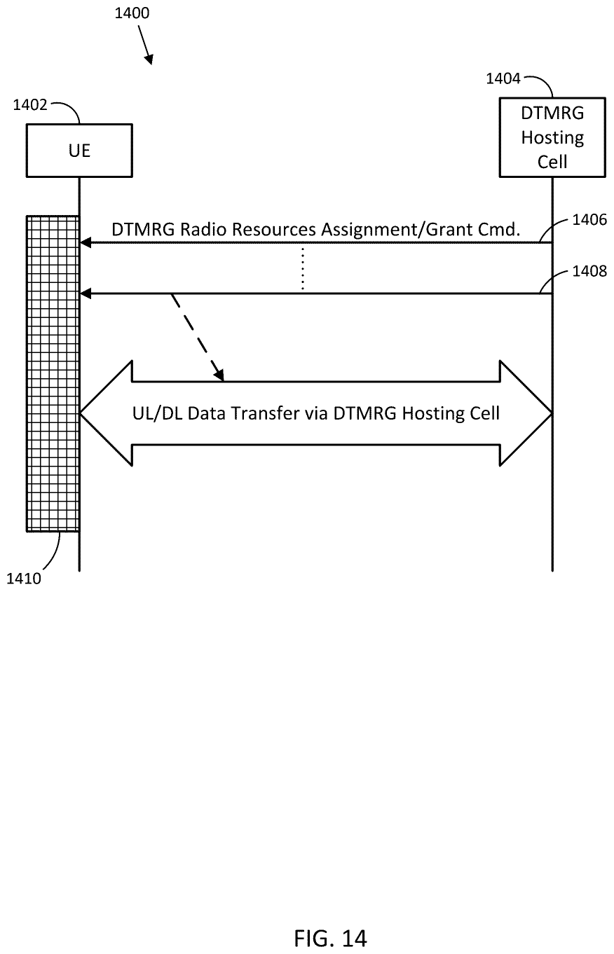

FIG. 14 illustrates an example signaling chart 1400 implementing the third scheme in accordance with some embodiments. For example, the signaling chart 1400 illustrates signals that may be exchanged and operations that may be performed as part of the third scheme for DTMRG radio resources assignments.

The signaling chart 1400 includes a UE 1402. The UE 1402 may include one or more of the features of the UE 104 (FIG. 1), the UE 106 (FIG. 1), the UE 200 (FIG. 2), the UE 504 (FIG. 5), the UE 602 (FIG. 6), the UE 802 (FIG. 8), the UE 902 (FIG. 9), the UE 1202 (FIG. 12), and/or the UE 1302 (FIG. 13). The signaling chart 1400 further includes a hosting cell 1404. The hosting cell 1404 may include one or more of the features of the hosting cell 508 (FIG. 5), the hosting cell 606 (FIG. 6), the hosting cell 806 (FIG. 8), the hosting cell 906 (FIG. 9), the hosting cell 1206 (FIG. 12), and/or the hosting cell 1306 (FIG. 13).

The hosting cell 1404 may provide DTMRG radio resources assignment/grant commands to the UE 1402, where the DTMRG radio resources assignment/grant commands provide radio resources assignment information for a measurements radio gap in which they are exchanged. For example, the hosting cell 1404 may generate and/or transmit a first DTMRG radio resources assignment/grant command 1406 and a second DTMRG radio resources assignment/grant command 1408 during a measurements radio gap instance 1410. The first DTMRG radio resources assignment/grant command 1406 and the second DTMRG radio resources assignment/grant command 1408 may include radio resources assignment information for the measurements radio gap instance 1410. The UE 1402 may identify the first DTMRG radio resources assignment/grant command 1406 and the second DTMRG radio resources assignment/grant command 1408, and may utilize the radio resources assignment information for one or more UL/DL data transfers 1412 via the hosting cell 1404 during the measurements radio gap instance 1410.

In some embodiments, aborting DTMRG gap instance approaches may be implemented. During DTMRG, if the serving cell requires the UE to abort the current DTMRG gap instance (e.g., latency critical data required to be transferred to the UE while the hosting cell is highly loaded and can't serve such data), the serving cell may request the DTMRG hosting cell to send a command to the UE to abort the gap and return back to the serving cell.

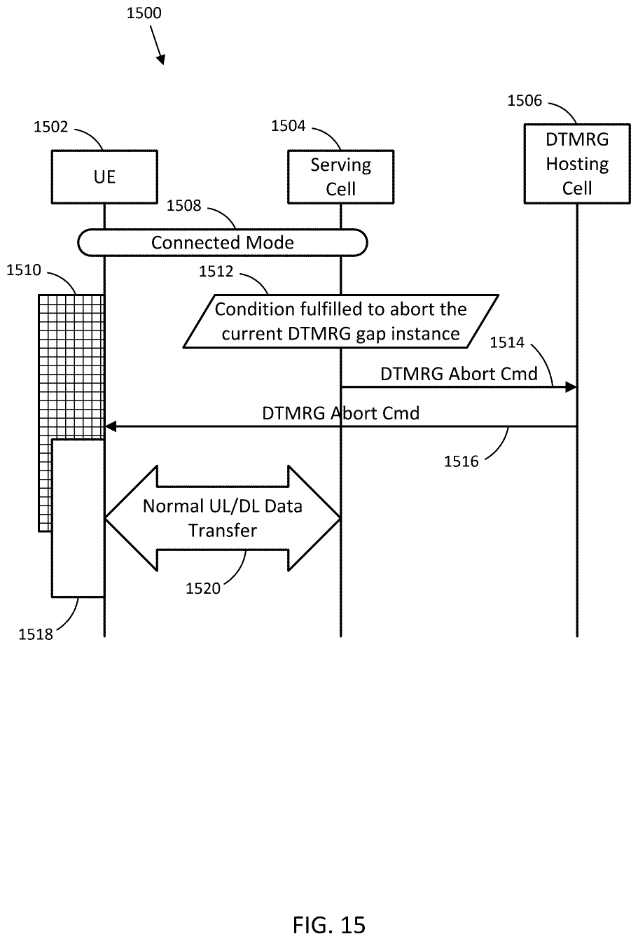

FIG. 15 illustrates an example signaling chart 1500 illustrating a DTMRG gap instance approach in accordance with some embodiments. For example, the signaling chart 1500 illustrates example signals that may be exchanged and operations that may be performed as part of aborting a DTMRG gap instance in accordance with approaches described herein.

The signaling chart 1500 includes a UE 1502. The UE 1502 may include one or more of the features of the UE 104 (FIG. 1), the UE 106 (FIG. 1), the UE 200 (FIG. 2), the UE 504 (FIG. 5), the UE 602 (FIG. 6), the UE 802 (FIG. 8), the UE 902 (FIG. 9), the UE 1202 (FIG. 12), the UE 1302 (FIG. 13), and/or the UE 1402 (FIG. 14). The signaling chart 1500 further includes a serving cell 1504 and a hosting cell 1506. The serving cell 1504 may include one or more of the features of the serving cell 506 (FIG. 5), the serving cell 604 (FIG. 6), the serving cell 804 (FIG. 8), the serving cell 904 (FIG. 9), the serving cell 1204 (FIG. 12), and/or the serving cell 1304 (FIG. 13). The hosting cell 1506 may include one or more of the features of the hosting cell 508 (FIG. 5), the hosting cell 606 (FIG. 6), the hosting cell 806 (FIG. 8), the hosting cell 906 (FIG. 9), the hosting cell 1206 (FIG. 12), the hosting cell 1306 (FIG. 13), and/or the hosting cell 1404 (FIG. 14).

The UE 1502 may be in a connected mode 1508 with the serving cell 1504, as illustrated by the connected mode 1508. The UE 1502 may implement a measurements radio gap instance 1510. The UE 1502 may be configured to exchange data with the hosting cell 1506 during the measurements radio gap instance 1510.

The serving cell 1504 may determine that a condition has been fulfilled to abort the measurements radio gap instance 1510 in 1512. For example, the serving cell may determine that latency critical data required to be transferred to the UE 1502 while the hosting cell 1506 cannot provide the latency critical data to the UE 1502 within an adequate time. Based on the determination that the condition is fulfilled, the serving cell 1504 cell may determine that the measurements radio gap instance 1510 is to be aborted. The serving cell 1504 may generate and/or transmit a DTMRG abort command 1514 to the hosting cell 1506. The DTMRG abort command 1514 indicates that the measurements radio gap instance 1510 is to be aborted.

The hosting cell 1506 may identify the DTMRG abort command 1514 received from the serving cell 1504 and may determine that the measurements radio gap instance 1510 is to be aborted based on the DTMRG abort command 1514. The hosting cell 1506 may generate and/or transmit a DTMRG abort command 1516 to the UE 1502. The DTMRG abort command 1516 may be the same as the DTMRG abort command 1514 or may include information from the DTMRG abort command 1514. The DTMRG abort command 1516 may indicate that the measurements radio gap instance 1510 is to be aborted. The DTMRG abort command 1516 may be an L1 downlink control information (DCI) command.

The UE 1502 may identify the DTMRG abort command 1516 received from the hosting cell 1506 during the measurements radio gap instance 1510. The UE 1502 may abort the measurements radio gap instance 1510 based at least in part on the DTMRG abort command 1516. The UE 1502 may transition to a normal operating state instance 1518 from the measurements radio gap instance 1510 when aborted, as indicated by the normal operating state instance 1518 overlapping a portion of the measurements radio gap instance 1510 in the illustrated embodiment. The UE 1502 and the serving cell 1504 may perform normal UL/DL data transfer 1520 via the serving cell 1504 during the normal operating state instance 1518.

UE UL transmission information may be provided for DTMRS Hosting Cell, example Time advance (e.g., 4G/5G TAC) & UL Power Control (e.g., 4G/5G TPC command), could be adjusted. For example, a UE may provide UL transmission information to be used for UL time alignment.

In a first option (Opt #1), time advance may be adjusted in one of the DTMRG gaps via a procedure (new procedure or customizing one of the already existing procedures) that includes the UE sending special UL signal to the hosting cell and based on which time advance (TimeAdvance)/power control (PwrControl) could be calculated by the hosting cell and sent back to the UE in a DL message (Msg), either via hosting cell within DTMRG gap or via serving cell after DTMRG gap.

Resources that shall be used within this procedure may be preconfigured as part of L3 DTMRG configurations, like special DTMRG gap instance (e.g., longer in length and having specific start offset) could be defined to be able to accommodate this procedure, and/or the radio resources information within which the DTMRG UL initial signal may be transmitted. Cellular NW may request the UE, via serving cell or hosting cell, retriggering this procedure whenever UL information adjustment is required.

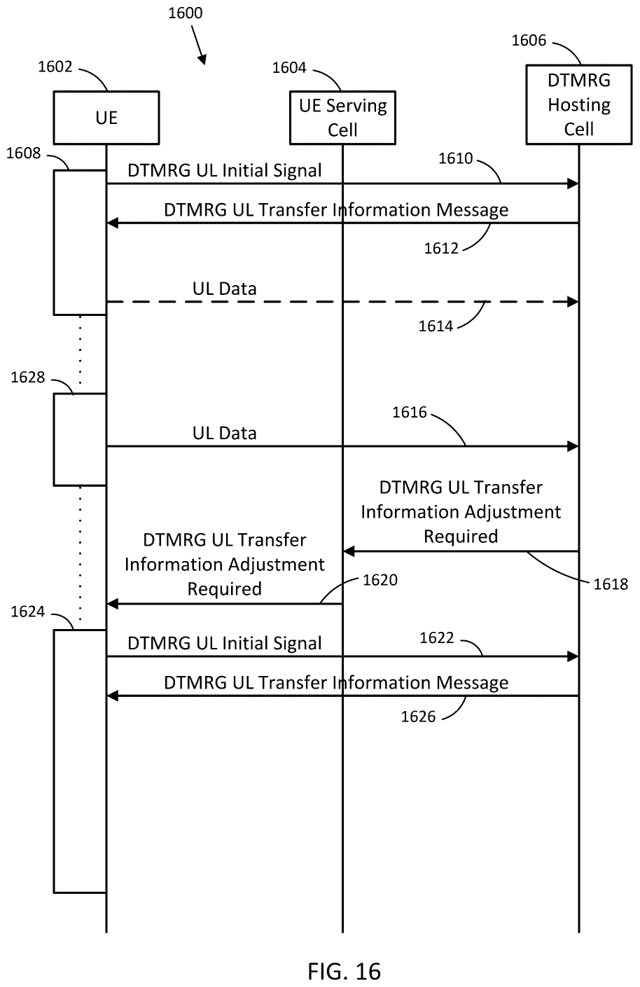

FIG. 16 illustrates an example signaling chart 1600 showing the first option for adjusting a time advance in accordance with some embodiments. For example, the signaling chart 1600 illustrates signals that may be exchanged and/or operations that may be performed for adjusting a time advance in accordance with the first option.

The signaling chart 1600 includes a UE 1602. The UE 1602 may include one or more of the features of the UE 104 (FIG. 1), the UE 106 (FIG. 1), the UE 200 (FIG. 2), the UE 504 (FIG. 5), the UE 602 (FIG. 6), the UE 802 (FIG. 8), the UE 902 (FIG. 9), the UE 1202 (FIG. 12), the UE 1302 (FIG. 13), the UE 1402 (FIG. 14), and/or the UE 1502 (FIG., 15). The signaling chart 1600 further includes a serving cell 1604 and a hosting cell 1606. The serving cell 1604 may include one or more of the features of the serving cell 506 (FIG. 5), the serving cell 604 (FIG. 6), the serving cell 804 (FIG. 8), the serving cell 904 (FIG. 9), the serving cell 1204 (FIG. 12), the serving cell 1304 (FIG. 13), and/or the serving cell 1504 (FIG. 15). The hosting cell 1606 may include one or more of the features of the hosting cell 508 (FIG. 5), the hosting cell 606 (FIG. 6), the hosting cell 806 (FIG. 8), the hosting cell 906 (FIG. 9), the hosting cell 1206 (FIG. 12), the hosting cell 1306 (FIG. 13), the hosting cell 1404 (FIG. 14), and/or the hosting cell 1506 (FIG. 15).

The UE 1602 may implement a first measurements radio gap instance 1608. The first measurements radio gap instance may be a special DTMRG gap instance that could be longer in length and/or have a specific start offset. The UE 1602 may generate and/or transmit a DTMRG UL initial signal 1610 to the hosting cell 1606 during the first measurements radio gap instance 1608. The DTMRG UL initial signal 1610 may include a preamble that can be used for time advance and/or power control adjustment.

The hosting cell 1606 may identify the DTMRG UL initial signal 1610 received from the UE 1602. The hosting cell 1606 may determine a timing advance and/or power control adjustment based at least in part on the DTMRG UL initial signal 1610. The hosting cell 1606 may generate and/or transmit a DTMRG UL transfer information message 1612 to the UE 1602 during the first measurements radio gap instance 1608. The DTMRG UL transfer information message 1612 may include information required for UE UL data transfer, such as the determined time advance and/or UL power control.

The UE 1602 may identify the DTMRG UL transfer information message 1612 received from the hosting cell 1606. The UE 1602 may store UL adjustment information from the DTMRG UL transfer information message 1612. The UE 1602 may store the UL adjustment information to be used in UL data transfers with the hosting cell 1606.

The UE 1602 may store and utilize the UL adjustment information for future UL data transmissions to the hosting cell 1606 during measurements radio gaps until the UE 1602 receives updated UL adjustment information. For example, the UE 1602 may utilize the UL adjustment information for a first UL data transmission 1614 during the first measurements radio gap instance 1608 and/or a second UL data transmission 1616 during a second measurements radio gap instance 1628.

The serving cell 1604 and/or the hosting cell 1606 may determine that a UL transfer information adjustment is to be performed. For example, the hosting cell 1606 may determine that a UL transfer information adjustment is to be performed. The hosting cell 1606 may generate and/or transmit a DTMRG UL transfer information adjustment request 1618 to the serving cell 1604. The DTMRG UL transfer information adjustment request 1618 may request that the UE 1602 transmit a DTMRG UL initial signal for UL transfer information determination.

The serving cell 1604 may identify the DTMRG UL transfer information adjustment request 1618 received from the hosting cell 1606. The serving cell 1604 may determine that the UE 1602 is to be provide a DTMRG UL initial signal to the hosting cell 1606. The serving cell 1604 may generate and/or transmit a DTMRG UL transfer information adjustment request 1620. The DTMRG UL transfer information adjustment request 1620 may indicate that the UE 1602 is to provide a DTMRG UL initial signal to the hosting cell 1606 in a next measurements radio gap instance.

The UE 1602 may identify the DTMRG UL transfer information adjustment request 1620 received from the serving cell 1604. The DTMRG UL transfer information adjustment request 1620 may trigger the UE 1602 to transmit a DTMRG UL initial signal to the hosting cell 1606 in the next measurements radio gap instance. For example, the UE 1602 may generate and/or transmit a second DTMRG UL initial signal 1622 to the hosting cell 1606 during a third measurements radio gap instance 1624. The third measurements radio gap instance 1624 may be a special DTMRG gap instance for UL transfer information adjustment.

The hosting cell 1606 may identify the second DTMRG UL initial signal 1622 received from the UE 1602. The hosting cell 1606 may determine a timing advance and/or power control adjustment based at least in part on the second DTMRG UL initial signal 1622. The hosting cell 1606 may generate and/or transmit a second DTMRG UL transfer information message 1626 to the UE 1602 during the third measurements radio gap instance 1624. The second DTMRG UL transfer information message 1626 may include information required for UE UL data transfer, such as the determined time advance and/or UL power control.

In a second option (which may be referred to as “Opt #2”), estimated UL transmission information (e.g., TimeAdvance & Power Control) for DTMRG hosting cell may be provided by the serving cell. For example, the serving cell 1604 may generate and/or transmit an estimated UL transmission information message to the UE 1602. The estimated UL transmission information for the hosting cell 1606, which may include estimated time advance and power control for the hosting cell 1606. The UE 1602 may identify the estimated UL transmission information message received from the serving cell 1604 and determine the estimated UL transmission information. The UE 1602 may utilize the estimated UL transmission information for UL data transmissions to the hosting cell, such as the first UL data transmission 1614 and/or the second UL data transmission 1616.

For DL transmission, DTMRG hosting cell radio resources assignment main information like modulation and coding scheme (MCS) may be provided. In a first option, basic configurations (e.g., MCS) value could be assumed to be used in radio resources allocation within DTMRG gaps, similar to semi-persistent/configured grant concept.

In a second option, the serving cell may configure the UE to perform measurements for DTMRG hosting cell specific resources that can be used for link adaption as part of L3 measurement configurations. Based on which the DTMRG, hosting cell could perform more optimal radio resources allocation for the UE within DTMRG gaps. An example may be measuring L1 non-zero power (NZP)/channel state information reference signal (CSI-RS) used for Hosting cell link adaptation with potentially multi-port multi layers/ports.

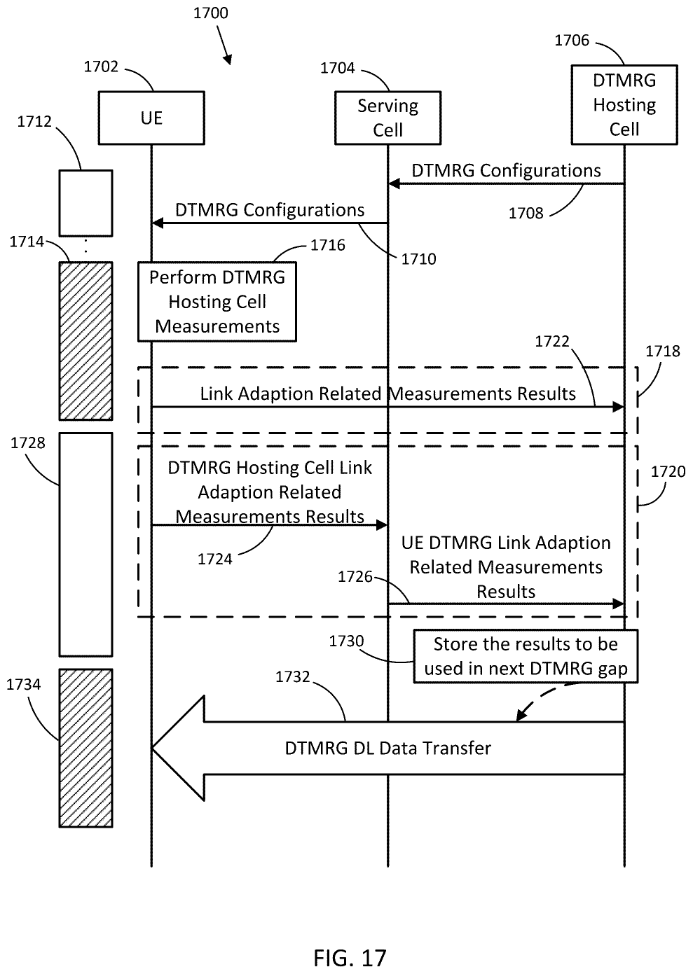

FIG. 17 illustrates an example signaling chart 1700 showing the DL transmission configuration in accordance with some embodiments. For example, the signaling chart 1700 illustrates signals that may be exchanged and/or operations that may be performed for DL transmission in DTMRG in accordance with the first option and the second option.

The signaling chart 1700 includes a UE 1702. The UE 1702 may include one or more of the features of the UE 104 (FIG. 1), the UE 106 (FIG. 1), the UE 200 (FIG. 2), the UE 504 (FIG. 5), the UE 602 (FIG. 6), the UE 802 (FIG. 8), the UE 902 (FIG. 9), the UE 1202 (FIG. 12), the UE 1302 (FIG. 13), the UE 1402 (FIG. 14), the UE 1502 (FIG. 15), and/or the UE 1602 (FIG. 16). The signaling chart 1700 further includes a serving cell 1704 and a hosting cell 1706. The serving cell 1704 may include one or more of the features of the serving cell 506 (FIG. 5), the serving cell 604 (FIG. 6), the serving cell 804 (FIG. 8), the serving cell 904 (FIG. 9), the serving cell 1204 (FIG. 12), the serving cell 1304 (FIG. 13), the serving cell 1504 (FIG. 15), and/or the serving cell 1604 (FIG. 16). The hosting cell 1706 may include one or more of the features of the hosting cell 508 (FIG. 5), the hosting cell 606 (FIG. 6), the hosting cell 806 (FIG. 8), the hosting cell 906 (FIG. 9), the hosting cell 1206 (FIG. 12), the hosting cell 1306 (FIG. 13), the hosting cell 1404 (FIG. 14), the hosting cell 1506 (FIG. 15), and/or the hosting cell 1606 (FIG. 16).

The hosting cell 1706 may generate and/or transmit a DTMRG configurations message 1708 to the serving cell 1704. The DTMRG configurations message 1708 may include one or more link adaption measurements, such as CSI-RS.

The serving cell 1704 may identify the DTMRG configurations message 1708 received from the hosting cell 1706. Based on the DTMRG configurations message 1708, the serving cell 1704 may generate and/or transmit a DTMRG configurations message 1710 to the UE 1702. The DTMRG configurations messages 1710 may include information from the DTMRG configurations message 1708. In some embodiments, the DTMRG configurations message 1710 may include link adaption measurements, such as CSI-RS. The serving cell 1704 may transmit to the UE 1702 while the UE 1702 is in a first normal operating state instance 1712.

The UE 1702 may identify the DTMRG configurations message 1710 received from the serving cell 1704. The UE 1702 may implement a first measurements radio gap instance 1714. The UE 1702 may perform one or more DTMRG hosting cell measurements 1716 during the first measurements radio gap instance 1714. The UE 1702 may utilize information from the DTMRG configurations message 1710 to perform the DTMRG hosting cell measurements 1716.

The signaling chart illustrates a first option 1718 corresponding to the first DL transmission configuration option and a second option 1720 corresponding to the second DL transmission configuration option. The transmissions within the dashed box corresponding to the first option 1718 may be exchanged as part of the first option. For example, the first option 1718 may have link adaption related measurements results provided directly to the hosting cell 1706 within the DTMRG gap. The transmissions within the dashed box corresponding to the second option 1720 may be exchanged as part of the second option. For example, the second option 1720 may have the link adaption related measurements provided to the hosting cell 1706 via the serving cell 1704. Either the first option 1718 or the second option 1720 may be implemented in different embodiments.

In the first option 1718, the UE 1702 may generate and/or transmit a link adaption related measurements results message 1722 to the hosting cell 1706 during the first measurements radio gap instance 1714. The link adaption related measurements results message 1722 may include the measurement results from the DTMRG hosting cell measurements 1716. The link adaption related measurements results message 1722 may be an L1 message.

In the second option, the UE 1702 may generate and/or transmit a DTMRG hosting cell link adaption related measurements results message 1724 to the serving cell 1704 during a second normal operating state instance 1728. The DTMRG hosting cell link adaption related measurements results message 1724 may include the results from the DTMRG hosting cell measurements 1716. The DTMRG hosting cell link adaption related measurements results message 1724 may transmitted via an L3 measurement report. The serving cell 1704 may identify the DTMRG hosting cell link adaption related measurements results message 1724. The serving cell 1704 may generate and/or transmit a UE DTMRG link adaption related measurements results message 1726 to the hosting cell 1706. The UE DTMRG link adaption related measurements results message 1726 may include information from the DTMRG hosting cell link adaption related measurement results message 1724.

The hosting cell 1706 may identify the link adaption related measurements results message 1722 received from the UE 1702 or the UE DTMRG link adaption related measurements results message 1726 received from the serving cell 1704, depending on the option implemented. The hosting cell 1706 may determine the results and store the results to be used in the next DTMRG gap 1730. The hosting cell 1706 may utilize the results for a DL data transfer 1732 during a second measurements radio gap 1734.

A second approach for addressing the UL/DL data transfer interruption may utilize measurement radio gap instance NW dynamic control. In the second approach radio measurements gaps may be skipped. During the connected mode, if the UE is configured with measurement radio gaps to be used for neighbor cells measurements and before one of the radio gap instances, the cellular network may identify (e.g., DL latency critical data received or UL latency critical data is pending on the UE) that there is latency critical data to be exchanged with the UE. The cellular network may send a command to the UE requesting skipping the next measurement radio gap instance to be able to receive/transmit data with the serving cell(s).

As an example, via sending L1 command (CMD) requesting the UE to skip the next measurement gap instance. L1 command could be as simple as UL/DL grants having data transfer scheduled within the measurement radio gap instance.

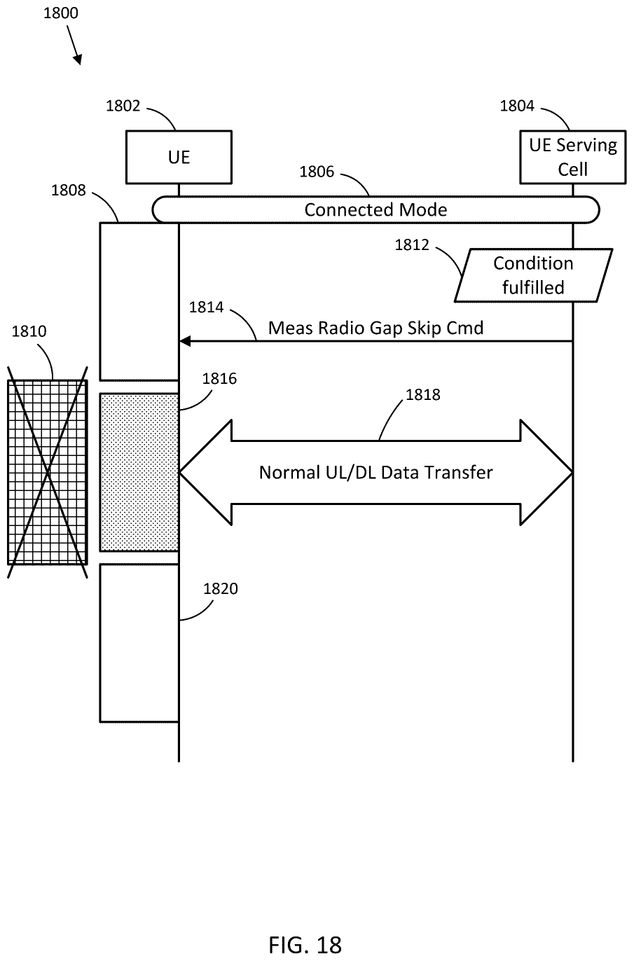

FIG. 18 illustrates an example signaling chart 1800 showing skipping a radio measurement gap in accordance with some embodiments. For example, the signaling chart 1800 illustrates signals that may be exchanged and/or operations that may be performed for skipping a measurement radio gap instance.

The signaling chart 1800 includes a UE 1802. The UE 1802 may include one or more of the features of the UE 104 (FIG. 1), the UE 106 (FIG. 1), the UE 200 (FIG. 2), the UE 504 (FIG. 5), the UE 602 (FIG. 6), the UE 802 (FIG. 8), the UE 902 (FIG. 9), the UE 1202 (FIG. 12), the UE 1302 (FIG. 13), the UE 1402 (FIG. 14), the UE 1502 (FIG. 15), UE 1602 (FIG. 16), and/or the UE 1702 (FIG. 17). The signaling chart 1800 further includes a serving cell 1804. The serving cell 1804 may include one or more of the features of the serving cell 506 (FIG. 5), the serving cell 604 (FIG. 6), the serving cell 804 (FIG. 8), the serving cell 904 (FIG. 9), the serving cell 1204 (FIG. 12), the serving cell 1304 (FIG. 13), the serving cell 1504 (FIG. 15), the serving cell 1604 (FIG. 16), and/or the serving cell 1704 (FIG. 17).

The UE 1802 may be in a connected mode with the serving cell 1804, as illustrated by connected mode 1806. The serving cell 1804 may be operating a serving cell for the UE 1802. The UE 1802 may initially be in a first normal operating state instance 1808. Further, the UE 1802 may be configured to implement a measurements radio gap instance 1810. The UE 1802 may be configured to perform one or more neighbor cells measurements during the measurements radio gap instance 1810.

Prior to the UE 1802 initiating the measurements radio gap instance 1810, the serving cell 1804 may determine that a condition is fulfilled for skipping the measurements radio gap instance 1810, as illustrated by 1812. In some embodiments, the condition that is fulfilled may be that there is latency critical data pending to be transferred to the UE 1802 and/or exchanged with the UE 1802 during a time scheduled for the measurements radio gap instance 1810. Based on the determination that the condition has been fulfilled, the serving cell 1804 may generate and/or transmit a measurements radio gap skip command 1814 to the UE 1802. In some embodiments, the measurements radio gap skip command 1814 may be an L1 command DCI UL/DL grant having data scheduled within the measurements radio gap instance 1810. The serving cell 1804 may transmit the measurements radio gap skip command 1814 during the first normal operating state instance 1808.

The UE 1802 may identify the measurements radio gap skip command 1814 received from the serving cell 1804. The UE 1802 may determine that the measurements radio gap instance 1810 is to be skipped based at least in part on the measurements radio gap skip command 1814. Rather than implementing the measurements radio gap instance 1810, the UE 1802 may enter a second normal operating state instance 1816, thereby skipping the measurements radio gap instance 1810. One or more normal UL/DL data transfers 1818 may be performed with the UE 1802 via the serving cell 1804 during the second normal operating state instance 1816. Accordingly, the serving cell 1804 may exchange data with UE 1802 during the second normal operating state instance 1816.

The UE 1802 may proceed with normal configured operation after skipping the measurements radio gap instance 1810. For example, the UE 1802 may implement a third normal operating state 1820 as originally configured.

In other embodiments, radio measurement gaps enablement may be implemented. For example, vise versa could be also possible, that the UE 1802 may not utilize measurements radio gaps, unless enablement command (e.g., L1 CMD) is received from NW. For example, the UE 1802 may be configured to remain in a normal operating state during times that are scheduled for measurements radio gaps unless the UE 1802 receives an enablement command from the serving cell 1804, where the enablement command may indicate that one or more following measurement radio gap instances are to be utilized for neighbor cells measurements.

The enablement command could be for a single measurement radio gap instance, multiple measurement radio gap instances, or unlimited so the UE could keep on utilizing radio measurements gaps as long as further command is not received from NW. For example, the enablement command may indicate that a single measurement radio gap instance is to be utilized for neighbor cells measurements, a certain number of measurement radio gap instances are to be utilized for neighbor cells measurements, or all measurement radio gap instances are to be utilized for neighbor cells measurements until a subsequent command is received from the serving cell 1804 indicating otherwise.

The enabled measurement radio gap instance(s) configurations (e.g., start offset, duration, periodicity) could be semi-static or dynamic. For semi-static, the enabled measurement radio gap instances configurations may be preconfigured by the cellular network, such as via L3/RRC configurations. For example, the serving cell 1804 may generate and/or transmit one or more configurations to the UE 1802 that preconfigure the enabled measurements radio gap instances for the UE. For dynamic, enablement may be received from the network in the enablement command. For example, the serving cell 1804 may generate and/or transmit enablement commands to the UE 1802 enabling measurement radio gap instances for neighbor cell measurements.

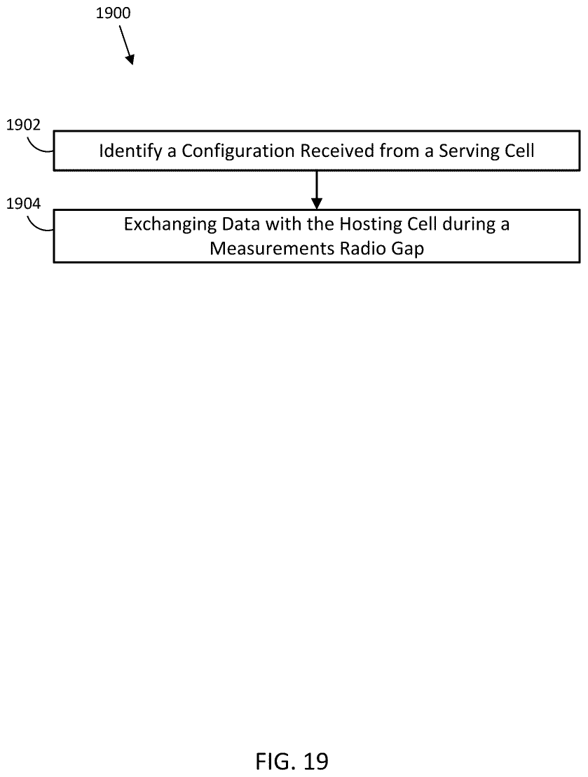

FIG. 19 illustrates an example procedure 1900 for exchanging data with a UE during a measurements radio gap in accordance with some embodiments. The procedure 1900 may be performed by a UE, such as the UE 104 (FIG. 1), the UE 106 (FIG. 1), the UE 200 (FIG. 2), the UE 504 (FIG. 5), the UE 602 (FIG. 6), the UE 802 (FIG. 8), the UE 902 (FIG. 9), the UE 1202 (FIG. 12), the UE 1302 (FIG. 13), the UE 1402 (FIG. 14), the UE 1502 (FIG. 15), UE 1602 (FIG. 16), the UE 1702 (FIG. 17), and/or the UE 1802 (FIG. 18).

The procedure 1900 may include identifying a configuration received from a serving cell in 1902. For example, the UE may identify a configuration received from a serving cell, the configuration providing configuration information for exchanging data with a hosting cell during measurements radio gaps. In some embodiments, the configuration may be received in a radio resource control (RRC) reconfiguration message.

In some embodiments, the procedure 1900 may include identifying a radio resources assignment command received from the serving cell, the radio resources assignment command indicating radio resources for exchanging the data with the hosting cell during the measurements radio gap. The radio resources assignment command may be received via one or more messages from the serving cell in some of these embodiments. In some of these embodiments, the radio resources assignment command may indicate that a frequency corresponding to the hosting cell is to be utilized for exchanging the data during the measurements radio gap.

In some embodiments, the procedure 1900 may include identifying a measurements radio gaps pattern received from the serving cell, the measurements radio gaps pattern indicating one or more measurements radio gaps to be utilized for exchanging data with the hosting cell. In some of these embodiments, the procedure 1900 may further include generating measurement reports or user equipment assistance information for transmission to the serving cell, the measurement reports or the user equipment assistance information to be utilized for determining the measurements radio gaps pattern.

In some embodiments, the procedure 1900 may include identifying radio resources assignment information received from the serving cell, the radio resources assignment information indicating radio resources to be utilized for exchanging data with the hosting cell. In some of these embodiments, the radio resources assignment information may include an uplink (UL) grant or a downlink (DL) grant.

In some embodiments, the procedure 1900 may include generating an uplink (UL) signal for transmission to the hosting cell, the UL signal to be utilized by the hosting cell for determining a UL time advance or UL power control. Further, the procedure 1900 may include identifying an indication of the UL time advance or the UL power control to be utilized for UL transmissions to the hosting cell.

In some embodiments, the procedure 1900 may include identifying estimated uplink (UL) transmission information received from the serving cell, the estimated UL transmission information to be utilized for UL transmissions to the hosting cell. In some of these embodiments, the estimated UL transmission information may include UL time advance information or UL power control information.

The procedure 1900 may include exchanging data with the hosting cell during a measurements radio gap in 1904. For example, the UE may exchange data with the hosting cell during a measurements radio gap in accordance with the configuration information.

In some embodiments, the measurements radio gap may be a first measurements radio gap. The procedure 1900 may include performing measurements on one or more frequencies during a second measurements radio gap, the second measurements radio gap occurring before the first measurements radio gap. The procedure 1900 may further include generating a report for transmission to the serving cell, the report including information for one or more cells detected via the measurements on the one or more frequencies, wherein the one or more cells includes the hosting cell. In some of these embodiments, the configuration may be a data transfer measurements radio gap configuration and the procedure 1900 may further include identifying a measurement configuration received from the serving cell, the measurement configuration indicating the one or more frequencies for performing the measurements.

In some embodiments, the procedure 1900 may include exchanging hybrid automatic repeat request (HARQ) feedback for the data with the hosting cell during the measurements radio gap. Further, the procedure 1900 may include exchanging hybrid automatic repeat request (HARQ) feedback for the data with the serving cell outside of the measurements radio gap. In some embodiments, the data may comprise hybrid automatic repeat request (HARQ) feedback for second data exchanged with the serving cell prior to the measurements radio gap. Further, exchanging the data may include exchanging multiple repetitions of the data with the hosting cell during the measurements radio gap in some embodiments.

In some embodiments, the procedure 1900 may include identifying a command received from the serving cell, the command indicating that a next measurements radio gap is to be utilized for exchanging data with the hosting cell, wherein the measurements radio gap is the next measurements radio gap. Further, the procedure may include identifying a radio resources assignment received from the serving cell, the radio resources assignment indicating radio resources to be utilized for exchanging data with the hosting cell in a next measurements radio gap, wherein the measurements radio gap is the next measurement radio gap in some embodiments. In some embodiments, the procedure 1900 may include identifying a radio resources assignment received from the hosting cell during the measurements radio gap, the radio resources assignment indicating radio resources to be utilized for exchanging data with the hosting cell during the measurements radio gap.

In some embodiments, the procedure 1900 may include identifying an abort command received from the hosting cell during the measurements radio gap, the abort command indicating that the measurements radio gap is to be aborted, and aborting the measurements radio gap based at least in part on identifying the abort command.

In some embodiments, the measurements radio gap may be a first measurements radio gap. The procedure 1900 may include performing hosting cell measurements related to link adaption, and generating a link adaption report for transmission to the serving cell or the hosting cell, the link adaption report including link adaption related measurement results produced by the hosting cell measurements. In some of these embodiments, the link adaption report may be for transmission to the hosting cell, and the link adaption report may be for transmission in a second measurements radio gap prior to the first measurements radio gap. In some of these embodiments, the procedure 1900 may further include identifying a hosting cell measurements configuration received from the serving cell, wherein the hosting cell measurements are performed in accordance with the hosting cell measurements configuration.

Any one or more of the operations in FIG. 19 may be performed in a different order than shown and/or one or more of the operations may be performed concurrently in embodiments. Further, it should be understood that one or more of the operations may be omitted from and/or one or more additional operations may be added to the procedure 1900 in other embodiments.

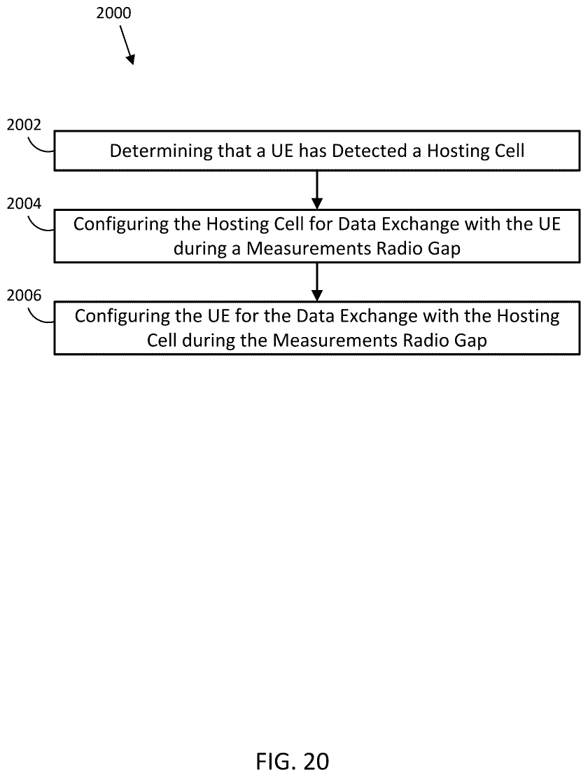

FIG. 20 illustrates an example procedure 2000 for configuring a hosting cell and a UE for a data exchange during a measurements radio gap in accordance with some embodiments. The procedure 2000 may be performed by a serving cell, such as the serving cell 506 (FIG. 5), the serving cell 604 (FIG. 6), the serving cell 804 (FIG. 8), the serving cell 904 (FIG. 9), the serving cell 1204 (FIG. 12), the serving cell 1304 (FIG. 13), the serving cell 1504 (FIG. 15), the serving cell 1604 (FIG. 16), the serving cell 1704 (FIG. 17), and/or the serving cell 1804 (FIG. 18).

In some embodiments, configuring the hosting cell for the data exchange may include generating a request for the data exchange with the UE for transmission to the hosting cell, and identifying a response received from the hosting cell, the response related to the data exchange. In some of these embodiments, the request may include a physical cell identifier (ID) for the hosting cell, UE measurements for the hosting cell, or a UE measurement pattern for a frequency of the hosting cell. In some of these embodiments, the response may include an identifier (ID) for the UE when operating on the hosting cell, or a cell physical layer configuration for performance of the data exchange.

The procedure 2000 may include determining that a UE has detected a hosting cell in 2002.

The procedure 2000 may include configuring the hosting cell for data exchange with the UE during a measurements radio gap in 2004. For example, the serving cell may configure the hosting cell for data exchange with the UE during a measurements radio gap of the UE, the data exchange being performed for a serving cell.

The procedure 2000 may include configuring the UE for the data exchange with the hosting cell during the measurements radio gap in 2006.

In some embodiments, the measurements radio gap of the UE may be a first measurements radio gap. The procedure 2000 may include configuring the UE to perform measurements of one or more frequencies during a second measurements radio gap occurring prior to the first measurements radio gap, and identifying a measurement report received from the UE, wherein determining that the UE has detected the hosting cell is based at least in part on the measurement report.

In some embodiments, the procedure 2000 may include generating a transfer request for transmission to the hosting cell, the transfer request including an identifier of the UE, information related to the measurement radio gap, an amount of data to be exchanged via the data exchange, or a UE power measurement for the hosting cell, and identifying a transfer confirmation received from the hosting cell, the transfer confirmation indicating that the transfer request is accepted, and the transfer confirmation including an amount of bytes allocated for the data exchange or grant information for the data exchange.

In some embodiments, the procedure 2000 may include generating a radio resources assignment command for transmission to the UE, wherein the radio resources assignment command includes an indication that a next radio gap instance is assigned for frequency measurements for a frequency of the hosting cell or radio sources information for the data exchange.

In some embodiments, the procedure 2000 may include generating a data transmission payload for transmission to the hosting cell, the data transmission payload including data for the data exchange. Further, the procedure 2000 may include identifying a data payload received from the hosting cell, the data payload including data received by the hosting cell during the data exchange in some embodiments.

In some embodiments, a medium access control (MAC) layer entity of the serving cell may communicate with a physical (PHY) layer entity of the hosting cell. In some of these embodiments, the MAC layer entity may generate downlink (DL) transmissions of the data exchange or processes uplink (UL) transmissions of the data exchange. In some of these embodiments, a hybrid automatic repeat request (HARQ) entity of the serving cell may perform HARQ operations related to the data exchange.

In some embodiments, the serving cell may communicate with a medium access control (MAC) layer entity of the hosting cell, the MAC layer entity serving the UE for the data exchange. In some of these embodiments, a hybrid automatic repeat request (HARQ) entity of the hosting cell may perform HARQ operations related to the data exchange.

In some embodiments, the procedure 2000 may include generating a measurement radio gaps pattern for transmission to the UE, the measurement radio gaps pattern indicating one or more measurements radio gaps to be utilized for one or more data exchanges between the UE and the hosting cell. In some of these embodiments, the procedure 2000 may further include identifying one or more measurement reports or UE assistance information received from the UE, wherein the measurement radio gaps pattern is generated based at least in part on the one or more measurement reports or the UE assistance information.

In some embodiments, the procedure 2000 may include generating a command for transmission to the UE, the command indicating a next measurements radio gap is to be utilized for the data exchange, wherein the measurements radio gap is the next measurements radio gap. In some of these embodiments, the command may include a layer 1 (L1) command or a grant having radio resources allocation. In some of these embodiments, the command may include a configuration identifier to be utilized for the data exchange.

In some embodiments, the procedure 2000 may include generating a semi-static radio resources assignment configuration for transmission to the UE, the semi-static radio resources assignment configuration to be utilized for one or more data exchanges during one or more measurements radio gaps.

In some embodiments, the procedure 2000 may include generating a radio resources assignment for transmission to the UE, the radio resources assignment to be utilized for a next measurements radio gap, wherein the measurements radio gap is the next measurements radio gap. In some of these embodiments, the procedure 2000 may further include identifying radio resources assignment information received from the hosting cell, the radio resources assignment information utilized for generation of the radio resources assignment.

In some embodiments, the procedure 2000 may include determining a condition for aborting the measurements radio gap has been fulfilled, and generate an abort command for transmission to the hosting cell, the abort command indicated that the measurements radio gap is to be aborted.

In some embodiments, the procedure 2000 may include configuring the UE to generate a special uplink (UL) signal for transmission to the hosting cell, the special UL signal to be utilized for time advance determination or power control determination. In some of these embodiments, the special UL signal may be a first special UL signal, and the procedure 2000 may further include triggering the UE to generate a second special UL signal for transmission to the hosting cell, the second special UL signal to be utilized for a second time advance determination or a second power control determination.

In some embodiments, the procedure 2000 may include generating an estimated uplink (UL) transmission information message for transmission to the UE, the estimated UL transmission information message including estimated UL transmission information for the hosting cell. In some of these embodiments, the estimated UL transmission information message may include time advance information for the hosting cell or power control information for the hosting cell.

In some embodiments, the procedure 2000 may include configuring the UE to perform measurements for specific resources of the serving cell, the measurements to be utilized for link adaption. In some of these embodiments, the procedure 2000 may further include identifying measurement configuration information received from the hosting cell, wherein the UE is configured to perform the measurements based at least in part on the measurement configuration information.

Any one or more of the operations in FIG. 20 may be performed in a different order than shown and/or one or more of the operations may be performed concurrently in embodiments. Further, it should be understood that one or more of the operations may be omitted from and/or one or more additional operations may be added to the procedure 2000 in other embodiments.

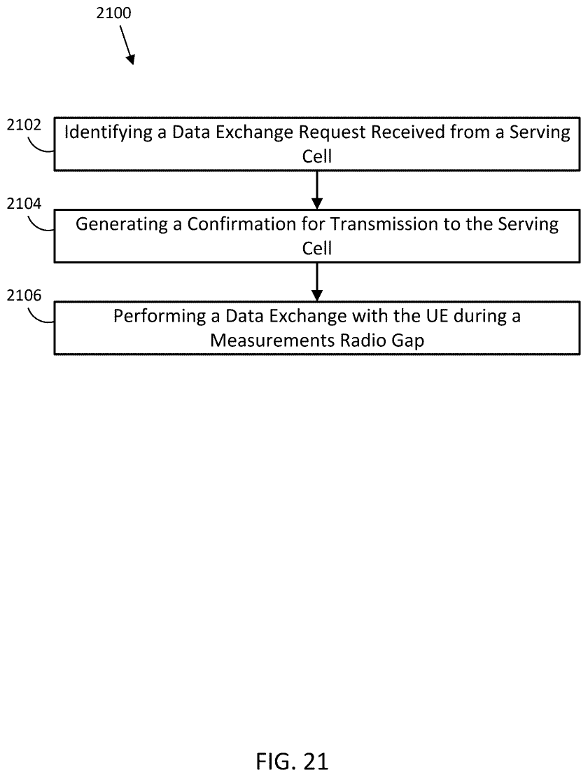

FIG. 21 illustrates an example procedure 2100 for performing a data exchange with a UE during a measurements radio gap in accordance with some embodiments. The procedure 2100 may be performed by a hosting cell, such as the hosting cell 508 (FIG. 5), the hosting cell 606 (FIG. 6), the hosting cell 806 (FIG. 8), the hosting cell 906 (FIG. 9), the hosting cell 1206 (FIG. 12), the hosting cell 1306 (FIG. 13), the hosting cell 1404 (FIG. 14), the hosting cell 1506 (FIG. 15), the hosting cell 1606 (FIG. 16), and/or the hosting cell 1706 (FIG. 17).

The procedure 2100 may include identifying a data exchange request received from a serving cell in 2102. For example, the hosting cell may identify a data exchange request received from a serving cell, the data exchange request requesting performance of one or more data exchanges with a user equipment (UE) on behalf of the serving cell during one or more measurements radio gaps. In some embodiments, the data exchange request may include a physical identifier (ID) for the UE, UE measurements for a hosting cell, or a UE measurement pattern for a frequency of the hosting cell.

The procedure 2100 may include generating a confirmation for transmission to the serving cell in 2104. For example, the hosting cell may generate a confirmation for transmission to the serving cell, the confirmation indicating that the one or more data exchanges are accepted. In some embodiments, the confirmation may include an identifier (ID) to be utilized by the UE while operating on a hosting cell or a physical layer configuration for the UE for performance of the data exchange.

The procedure 2100 may include performing a data exchange with the UE during a measurements radio gap in 2106.

In some embodiments, the procedure 2100 may include identifying transfer request information received from the serving cell, the transfer request information related to the measurements radio gap, and generating a transfer request information confirmation for transmission to the serving cell based at least in part on the transfer request information. In some of these embodiments, the transfer request information may include an identifier (ID) of the UE, radio gap instance information related to the measurements radio gap, an amount of data to be exchanged in the data exchange, UE measurement values for a hosting cell, or a start time and duration of the measurements radio gap. In some of these embodiments, the transfer request information confirmation may include an amount of bytes allocated for the data exchange or grant information for the data exchange.

In some embodiments, the procedure 2100 may include identifying a downlink (DL) payload from the serving cell, the DL payload including DL data to be provided to the UE in the data exchange, and generating a DL transmission for transmission to the UE during the measurements radio gap, the DL transmission including the DL data. Further, the procedure 2100 may include identifying uplink (UL) data received from the UE during the measurements radio gap, and generating a UL payload for transmission to the serving cell, the UL payload including the UL data.

In some embodiments, data may be exchanged with the serving cell and the UE via a physical (PHY) layer entity of a hosting cell.

In some embodiments, a dedicated medium access control (MAC) entity of a hosting cell may serve the data exchanged in the data exchange during the measurements radio gap. In some of these embodiments, a dedicated hybrid automatic repeat request (HARQ) entity of the hosting cell may be to perform HARQ operations for the data exchange.

In some embodiments, the data exchange may include exchange of data with the UE during the measurements radio gap, and exchange of hybrid automatic repeat request (HARQ) feedback with the UE during the measurements radio gap, the HARQ feedback related to the data. Further, the data exchange may include exchange of hybrid automatic repeat request (HARQ) feedback with the UE during the measurements radio gap, the HARQ feedback related to data exchanged outside of the measurements radio gap in some embodiments. In some embodiments, the data exchange may include exchange of one or more repetitions of data with the UE during the measurements radio gap.

In some embodiments, the procedure 2100 may include generating a radio resources assignment information communication for transmission to the serving cell, the radio resources assignment information communication including radio resources assignment information for the data exchange. Further, the procedure 2100 may include generating a radio resources assignment command for transmission to the UE during the measurements radio gap, the radio resources assignment command including radio resources assignments for the data exchange.

In some embodiments, the procedure 2100 may include identifying an abort command received from the serving cell, the abort command indicating the measurements radio gap is to be aborted, and generating an abort gap command for transmission to the UE during the measurements radio gap, the abort gap command indicating that the UE is to abort the measurements radio gap and return to operation with the serving cell.

In some embodiments, the procedure 2100 may include identifying an uplink (UL) initial signal received from the UE during the measurements radio gap, determining a time advance or a power control based at least in part on the UL initial signal, and generating a UL transfer information message for transmission to the UE during the measurements radio gap, the UL transfer information message including the time advance or the power control. In some of these embodiments, the procedure 2100 may include generating a trigger message for transmission to the UE, the trigger message to cause the UE to provide the UL initial signal. In some of these embodiments, the procedure 2100 may include generating a trigger message for transmission to the serving cell, the trigger message to cause the serving cell to request that the UE provide the UL initial signal. In some of these embodiments, the UL initial signal may include a preamble used for determining the time advance or the power control.

In some embodiments, the procedure 2100 may include identifying link adaption related measurement results received from the UE, determining a link adaption based at least in part on the link adaption related measurement results, and utilizing the link adaption for a next measurements radio gap.

In some embodiments, the procedure 2100 may include identifying link adaption related measurement results received from the serving cell, determining a link adaption based at least in part on the link adaption related measurement results, and utilizing the link adaption for a next measurements radio gap.

Any one or more of the operations in FIG. 21 may be performed in a different order than shown and/or one or more of the operations may be performed concurrently in embodiments. Further, it should be understood that one or more of the operations may be omitted from and/or one or more additional operations may be added to the procedure 2100 in other embodiments.

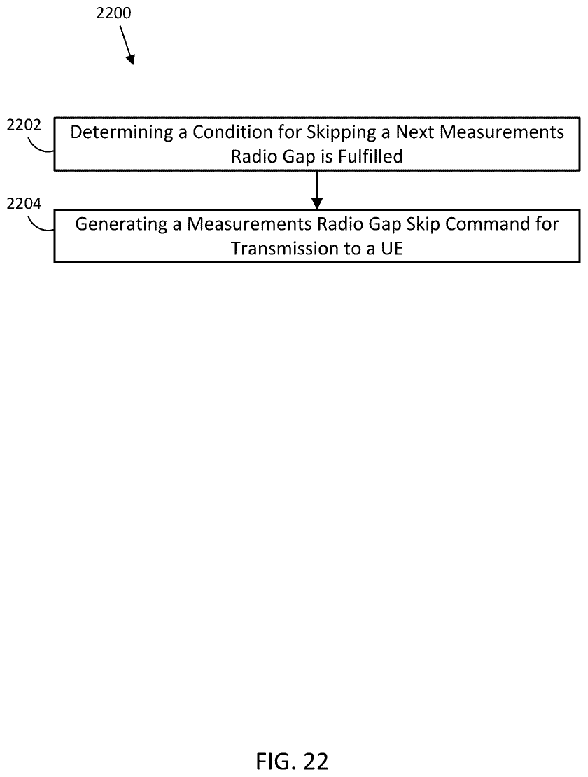

FIG. 22 illustrates an example procedure 2200 for causing a UE to skip a next measurements radio gap in accordance with some embodiments. The procedure 2200 may be performed by a serving cell, such as the serving cell 506 (FIG. 5), the serving cell 604 (FIG. 6), the serving cell 804 (FIG. 8), the serving cell 904 (FIG. 9), the serving cell 1204 (FIG. 12), the serving cell 1304 (FIG. 13), the serving cell 1504 (FIG. 15), the serving cell 1604 (FIG. 16), the serving cell 1704 (FIG. 17), and/or the serving cell 1804 (FIG. 18).

The procedure 2200 may include determining a condition for skipping a next measurements radio gap is fulfilled in 2202.

The procedure 2200 may include generating a measurements radio gap skip command for transmission to a UE in 2204. For example, the serving cell may generate a measurements radio gap skip command for transmission to a user equipment (UE), the measurements radio gap skip command to cause the UE to skip the next measurements radio gap.

In some embodiments, the measurements radio gap skip command may be a layer 1 (L1) command. Further, the measurements radio gap skip command may include one or more grants for data transfer scheduled within the next measurements radio gap in some embodiments.

Any one or more of the operations in FIG. 22 may be performed in a different order than shown and/or one or more of the operations may be performed concurrently in embodiments. Further, it should be understood that one or more of the operations may be omitted from and/or one or more additional operations may be added to the procedure 2200 in other embodiments.

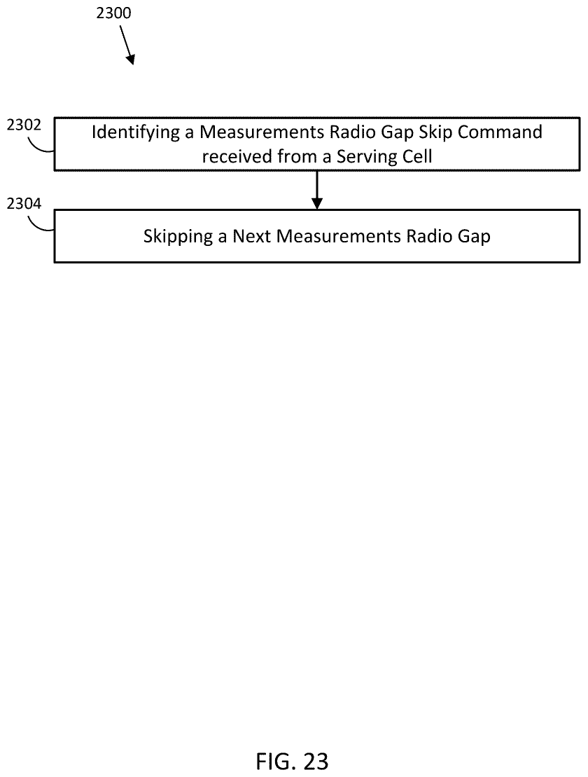

FIG. 23 illustrates an example procedure 2300 for skipping a next measurements radio gap in accordance with some embodiments. The procedure 2300 may be performed by a UE, such as the UE 104 (FIG. 1), the UE 106 (FIG. 1), the UE 200 (FIG. 2), the UE 504 (FIG. 5), the UE 602 (FIG. 6), the UE 802 (FIG. 8), the UE 902 (FIG. 9), the UE 1202 (FIG. 12), the UE 1302 (FIG. 13), the UE 1402 (FIG. 14), the UE 1502 (FIG. 15), UE 1602 (FIG. 16), the UE 1702 (FIG. 17), and/or the UE 1802 (FIG. 18).

The procedure 2300 may include identifying a measurements radio gap skip command received from a serving cell in 2302. In some embodiments, the measurements radio gap skip command may be received via layer 1 (L1) signaling. Further, the measurements radio gap skip command may include one or more grants for data transfer scheduled within the next measurements radio gap in some embodiments.

The procedure 2300 may include skipping a next measurements radio gap in 2304. For example, the UE may skip a next measurements radio gap based at least in part on the measurements radio gap skip command. In some embodiments, skipping the next measurements radio gap may include allowing data transfer to be scheduled with the serving cell during the next measurements radio gap.

Any one or more of the operations in FIG. 23 may be performed in a different order than shown and/or one or more of the operations may be performed concurrently in embodiments. Further, it should be understood that one or more of the operations may be omitted from and/or one or more additional operations may be added to the procedure 2300 in other embodiments.

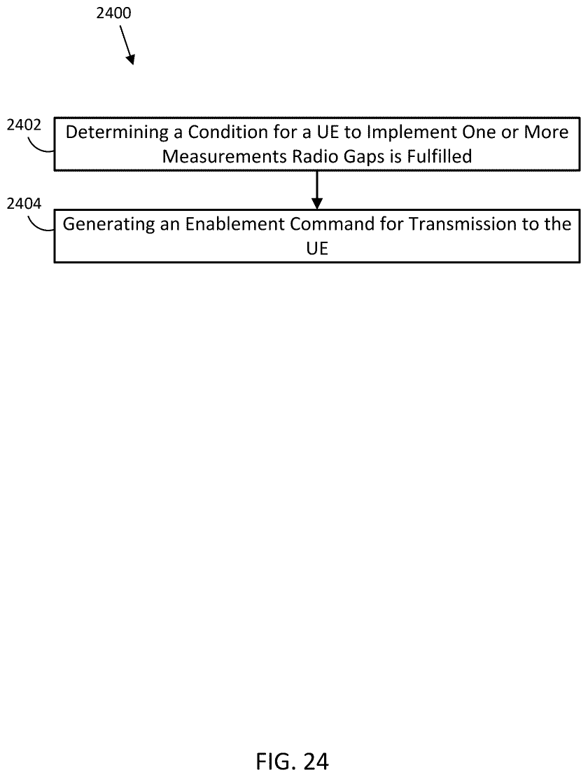

FIG. 24 illustrates an example procedure 2400 for enabling one or more measurements radio gaps in accordance with some embodiments. The procedure 2400 may be performed by a serving cell, such as the serving cell 506 (FIG. 5), the serving cell 604 (FIG. 6), the serving cell 804 (FIG. 8), the serving cell 904 (FIG. 9), the serving cell 1204 (FIG. 12), the serving cell 1304 (FIG. 13), the serving cell 1504 (FIG. 15), the serving cell 1604 (FIG. 16), the serving cell 1704 (FIG. 17), and/or the serving cell 1804 (FIG. 18).

The procedure 2400 may include determining a condition for a user equipment (UE) to implement one or more measurements radio gaps is fulfilled in 2402.

The procedure 2400 may include generating an enablement command for transmission to the UE in 2404. For example, the serving cell may generate an enablement command for transmission to the UE, the enablement command indicating that the UE is to implement the one or more measurements radio gaps.

In some embodiments, the one or more measurements radio gaps may include a single measurements radio gap instance. Further, the one or more measurements radio gaps may include multiple measurements radio gap instances in some embodiments. In some embodiments, the enablement command may indicate that the UE is to implement measurement radio gap instances until a subsequent command is received.

In some embodiments, the procedure 2400 may include generating an enabled measurement radio gap instance configuration for transmission to the UE, the enabled measurement radio gap instance configuration indicating a start offset for the one or more measurements radio gaps, a duration for the one or more measurements radio gaps, or a periodicity of the one or more measurements radio gaps.

In some embodiments, the enablement command may indicate a start offset for the one or more measurements radio gaps, a duration for the one or more measurements radio gaps, or a periodicity of the one or more measurements radio gaps.

Any one or more of the operations in FIG. 24 may be performed in a different order than shown and/or one or more of the operations may be performed concurrently in embodiments. Further, it should be understood that one or more of the operations may be omitted from and/or one or more additional operations may be added to the procedure 2400 in other embodiments.

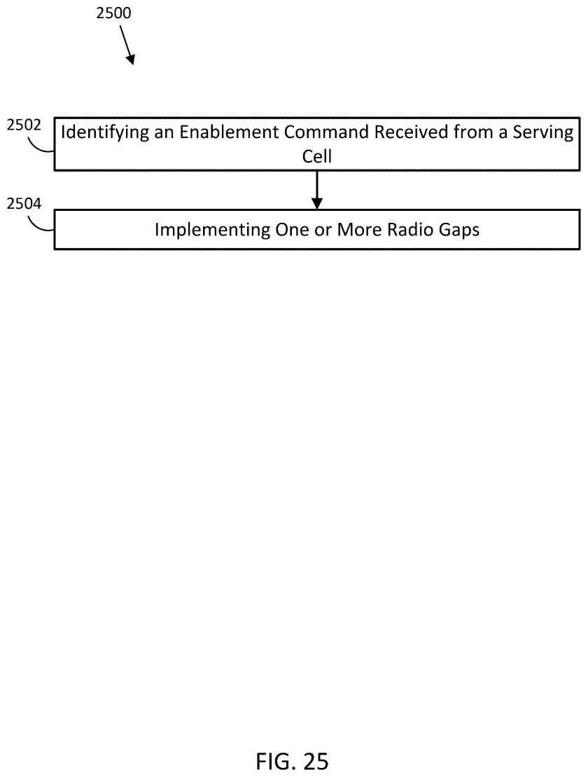

FIG. 25 illustrates an example procedure 2500 for implementing one or more measurements radio gaps in accordance with some embodiments. The procedure may be performed by a UE, such as the UE 104 (FIG. 1), the UE 106 (FIG. 1), the UE 200 (FIG. 2), the UE 504 (FIG. 5), the UE 602 (FIG. 6), the UE 802 (FIG. 8), the UE 902 (FIG. 9), the UE 1202 (FIG. 12), the UE 1302 (FIG. 13), the UE 1402 (FIG. 14), the UE 1502 (FIG. 15), UE 1602 (FIG. 16), the UE 1702 (FIG. 17), and/or the UE 1802 (FIG. 18).

The procedure 2500 may include identifying an enablement command received from a serving cell in 2502.

The procedure 2500 may include implementing one or more radio gaps in 2504. For example, the UE may implement one or more measurements radio gaps based at least in part on the enablement command.

In some embodiments, the enablement command may indicate that a single measurements radio gap instance is to be implemented, and implementing the one or more measurements radio gaps may include implementing the single measurements radio gap instance.

In some embodiments, the enablement command may indicate that multiple measurements radio gap instances are to be implemented, and implementing the one or more measurements radio gaps may include implementing the multiple measurements radio gap instances.

In some embodiments, the enablement command may indicate that measurements radio gap instances are to be implemented until a subsequent command is received, and implementing the one or more measurements radio gaps may include implementing measurements radio gap instances until the subsequent command is received.

In some embodiments, the procedure 2500 may include identifying an enabled measurement radio gap instance configuration received from the serving cell, and determining a start offset for the one or more measurements radio gaps, a duration for the one or more measurements radio gaps, or a periodicity of the one or more measurements radio gaps based at least in part on the enabled measurement radio gap instance configuration.

In some embodiments, the procedure 2500 may include determining a start offset for the one or more measurements radio gaps, a duration for the one or more measurements radio gaps, or a periodicity of the one or more measurements radio gaps based at least in part on the enablement command.

Any one or more of the operations in FIG. 25 may be performed in a different order than shown and/or one or more of the operations may be performed concurrently in embodiments. Further, it should be understood that one or more of the operations may be omitted from and/or one or more additional operations may be added to the procedure 2500 in other embodiments.

A third approach may include UE dynamic measurement radio gaps length modification. During Connected Mode, as per 3GPP requirements, the UE is having timing performance requirement defining Tdetect “Cells Detection” and/or Tmeasure “Detected Cells Measurements.” Tdetect “Cells Detection” may be the maximum time by which the UE shall detect new cells. Tmeasure “Detected Cells Measurements” may be the maximum time by which the UE shall measure the already detected cells. Since Tdetect is much bigger than Tmeasure and cell detection requires more processing power from the UE, the UEs typically don't perform Cell Detection in every Meas Gap instance, but only the minimal required to fulfill Tdetect 3GPP requirements.

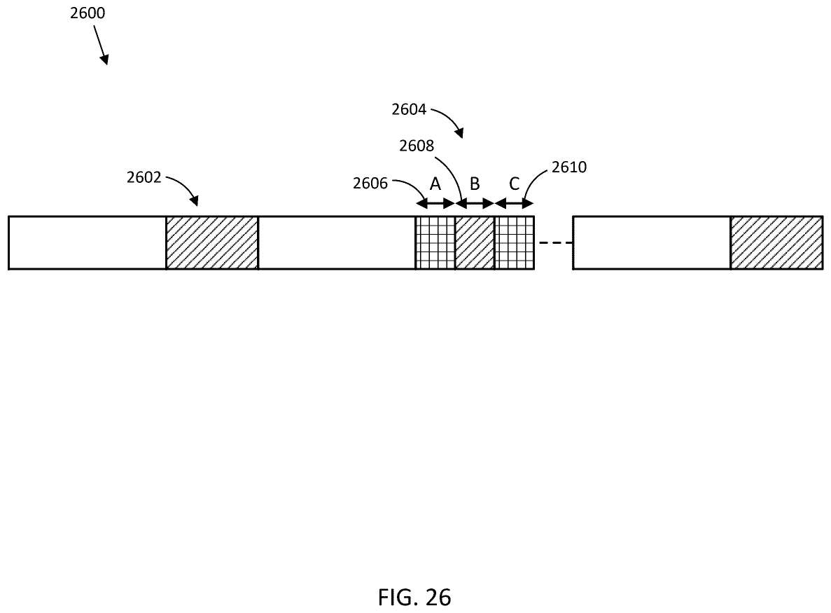

To measure already detected Cell(s), since the cell timing is already known by the UE (e.g., exact location of SSB for a 5G cell), the UE may use radio for measuring only specific duration within Meas Radio Gap and the remaining duration within Meas Radio Gap is not utilized in measurement radio operation. An issue may be that since the network (NW) is not aware that the UE will utilize the next Meas Radio Gap instance, the un-utilized part of the Meas radio Gap may not be allocated for data transfer operations. Example Meas Radio Gap Part A and Part C in FIG. 26 are neither utilized in data transfer operation nor in measurement operation.

FIG. 26 illustrates an example measurement timing arrangement 2600 in accordance with some embodiments. For example, the arrangement 2600 illustrates a timing representation showing measurement gaps for performing measurements. A UE may be configured with a measurement configuration to perform the operations in accordance with the arrangement 2600.

The arrangement 2600 may include portions with normal serving cells radio operations and portions with radio gaps where the UE performs measurements on neighbor cells. In particular, rectangles illustrated in the arrangement 2600 without fill illustrate portions with normal serving cells radio operations. Rectangles illustrated in the arrangement 2600 with diagonal line fill illustrate portions with radio gaps where the UE performs measurements on neighbor cells.

The arrangement 2600 includes a first measurement gap 2602. The first measurement gap 2602 may be a fully utilized MeasGap for detecting new cells. For example, a UE may utilize the entire first measurement gap 2602 for detecting new cells.

The arrangement 2600 includes a second measurement gap 2604. The second measurement gap 2604 may be a partially utilized MeasGap used for measuring already detected cells. The second measurement gap 2604, being a partially utilized MeasGap, may be divided into portions that are used for measurements of detected cells and other portions that are not utilized for measurements. In the illustrated embodiment, the second measurement gap 2604 includes a first part 2606 (“Part A”), a second part 2608 (“Part B”), and a third part 2610 (“Part C”). The second part 2608 may be used only for measuring already detected cells. The first part 2606 and the third part 2610 may not be utilized in any radio activity. In particular, the first part 2606 and the third part 2610 may not be allocated for data transfer operations nor measurement operations.

For the partially utilized measurement radio gaps, the UE may inform the NW about the duration that will not be utilized within the gap. For example, the UE may transmit information to a base station regarding a duration that will not be utilized in a measurement gap for measuring already detected cells. Accordingly, the NW may schedule the UE within these durations for data transfer operations via the UE serving cell(s). The UE may follow the serving cell(s) physical channels within these durations to act on the NW data-transfer durations within these utilized Measurements Radio Gap durations. Utilizing the durations for data transfer operations may provide for more efficient operation of the UE.

The UE may indicate to the NW a pattern (e.g., start, periodicity) of Meas Radio Gaps that will be partially utilized and the corresponding un-utilized duration. The UE may indicate to the NW that the next Meas radio Gap instance(s) would be completely skipped (i.e., can be scheduled for data transfer operations). The UE may initiate this operation based on 3GPP defined requirements, like if low latency critical UL data is pending and primary serving cell (e.g., primary cell (PCell)) in a good channel condition (e.g., its power (PWR) better than certain threshold).

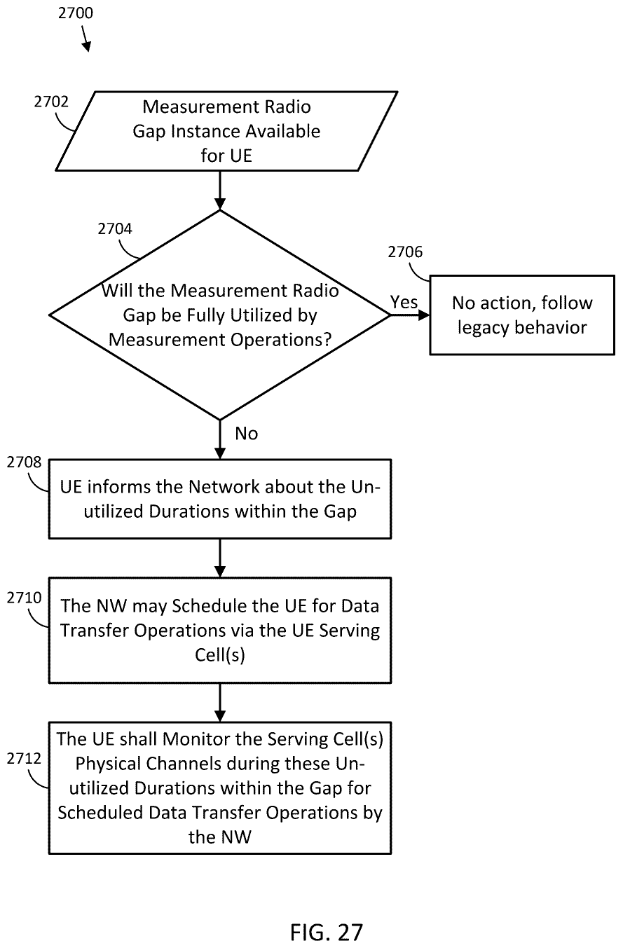

FIG. 27 illustrates an example procedure 2700 in accordance with some embodiments. The procedure 2700 may be implemented for determining whether a measurement gap is being fully utilized and scheduling data transfer operations in the measurement gap if it is not being fully utilized. The procedure 2700 may be performed by a system, where the system may include one or more UEs, one or more base stations, and/or one or more core networks.

The procedure 2700 may include identifying a measurement radio gap instance available for a UE in 2702. For example, the UE may be scheduled with a measurement radio gap instance by a base station. The UE may identify the measurement radio gap instance. In other embodiments, the base station may identify the measurement radio gap instance.

The procedure 2700 may include determining whether the measurement radio gap will be fully utilized by measurement operations in 2704. For example, the UE may determine whether the measurement radio gap instance identified in 2702 will be fully utilized by measurement operations. In embodiments where the base station identifies the measurement radio gap instance, the base station may transmit a request for the UE to determine whether the measurement radio gap instance will be fully utilized by measurement operations.

If the UE determines that the measurement radio gap instance will be fully utilized by measurement operations in 2704, the procedure 2700 may proceed to 2706. In 2706, no action may be taken and legacy behavior may be followed for the measurement radio gap instance.

If the UE determines that the measurement radio gap instance will not be fully utilized by measurement operations in 2704, the procedure 2700 may proceed to 2708. The procedure 2700 may include the UE informing the NW about the un-utilized durations within the gap in 2708. For example, the UE may generate a communication that includes information for the un-utilized durations within the measurement radio gap instance identified in 2702. The information may include data that can be utilized by the network for determining characteristics of the un-utilized durations, such as timing of the un-utilized durations. In some embodiments, the information may include an indication of a start time of an un-utilized duration, an end time of the un-utilized duration, a pattern (including a start of the un-utilized duration and a periodicity of the un-utilized duration) of the measurement radio gap including the un-utilized duration, or some combination thereof. The UE may transmit the communication to a base station of the network.

The procedure 2700 may include the NW scheduling the UE for data transfer operations via the UE serving cell or serving cells in 2710. For example, the NW may schedule the UE with data transfer operations during the un-utilized durations indicated in 2708. In some embodiments, a base station of the NW may generate one or more grants, assignments, or other scheduling communications for data transfers between the UE and one or more serving cells during the un-utilized durations. The base station may transmit the grants, assignments, or other scheduling communications to the UE to configure the UE to perform data transfer operations with the serving cells during the un-utilized durations.

The procedure 2700 may include the UE monitoring the serving cell(s) physical channels during the un-utilized durations within the gap for scheduled data transfer operations by the NW in 2712. For example, the UE may be configured to monitor one or more physical channels of one or more serving cells during the un-utilized durations indicated in 2708 for data transfer operations scheduled by the NW.

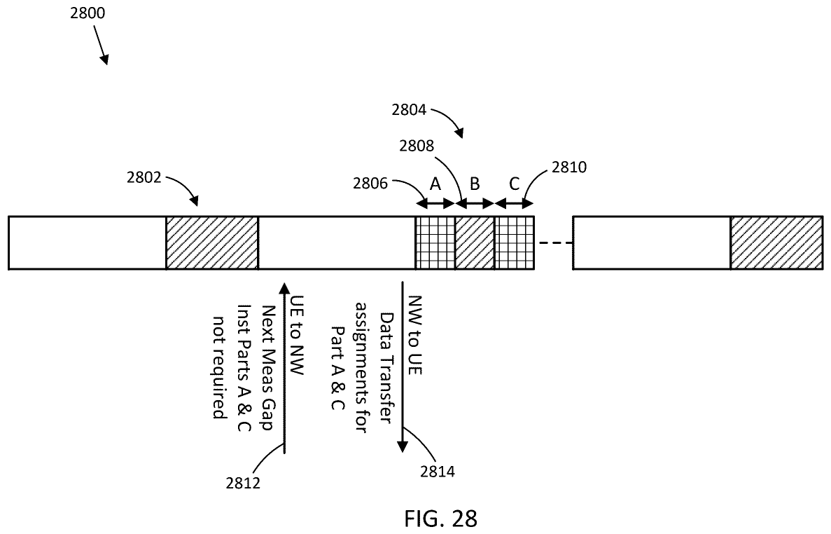

FIG. 28 illustrates an example measurement timing arrangement 2800 in accordance with some embodiments. For example, the arrangement 2800 illustrates a timing representation showing measurement gaps for performing measurements. A UE may be configured with a measurement configuration to perform the operations in accordance with the arrangement 2800.

The arrangement 2800 may include portions with normal serving cells radio operations, portions with radio gaps where the UE performs measurements on neighbor cells, and portions with un-utilized measurement gap durations that are utilized for serving cells operation. In particular, rectangles illustrated in the arrangement 2800 without fill illustrate portions with normal serving cells radio operations. Rectangles illustrated in the arrangement 2800 with diagonal line fill illustrate portions with radio gaps where the UE performs measurements on neighbor cells. Rectangles illustrated in the arrangement 2800 with the crosshatch fill illustrate portions with un-utilized measurement gap durations that are utilized for serving cells operation.

The arrangement 2800 includes a first measurement gap 2802. The first measurement gap 2802 may be a full utilized MeasGap for detecting new cells. For example, a UE may utilize the entire first measurement gap 2802 for detecting new cells.

The arrangement 2800 includes a second measurement gap 2804. The second measurement gap 2804 may be a partially utilized MeasGap used for measuring already detected cells. The second measurement gap 2804, being a partially utilized MeasGap, may be divided into portions that are used for measurements of detected cells and other portions that are not utilized for measurements. In the illustrated embodiment, the second measurement gap 2804 includes a first part 2806 (“Part A”), a second part 2808 (“Part B”), and a third part 2810 (“Part C”). The second part 2808 may be used only for measuring already detected cells.

The first part 2806 and the third part 2810 may be utilized for data transfer operations with serving cells. For example, the UE may generate a transmission 2812 that indicates that the next measurement gap (in the illustrated instance, the second measurement gap 2804) includes the first part 2806 and the third part 2810 which are not to be utilized for measurements. The UE may transmit the transmission 2812 to the NW, such as via a base station.

The NW may identify the transmission 2812 from the UE and determine information (such as timing) regarding the first part 2806 and the third part 2810. The NW may determine schedule one or more data transfers with the UE during the first part 2806 and/or the third part 2810. The NW may generate one or more data transfer assignments 2814 for data transfers to be performed during the first part 2806 and/or the third part 2810. The NW may transmit (such as via a base station) the data transfer assignments 2814 to the UE.

The UE may identify the data transfer assignments 2814 from the NW. The UE may determine that one or more data transfers are scheduled during the first part 2806 and/or the third part 2810 based on the data transfer assignments 2814. The UE may monitor one or more physical channels of one or more serving cells during the first part 2806 and/or third part 2810 for the scheduled data transfers.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method comprising identifying a configuration received from a serving cell, the configuration providing configuration information for exchanging data with a hosting cell during measurements radio gaps, and exchanging data with the hosting cell during a measurements radio gap in accordance with the configuration information.

Example 2 may include the method of example 1, wherein the configuration is received in a radio resource control (RRC) reconfiguration message.

Example 3 may include the method of example 1, wherein the measurements radio gap is a first measurements radio gap, and wherein the method further comprises performing measurements on one or more frequencies during a second measurements radio gap, the second measurements radio gap occurring before the first measurements radio gap, and generating a report for transmission to the serving cell, the report including information for one or more cells detected via the measurements on the one or more frequencies, wherein the one or more cells includes the hosting cell.

Example 4 may include the method of example 3, wherein the configuration is a data transfer measurements radio gap configuration, and wherein the method further comprises identifying a measurement configuration received from the serving cell, the measurement configuration indicating the one or more frequencies for performing the measurements.

Example 5 may include the method of example 1, further comprising identifying a radio resources assignment command received from the serving cell, the radio resources assignment command indicating radio resources for exchanging the data with the hosting cell during the measurements radio gap.

Example 6 may include the method of example 5, wherein the radio resources assignment command is received via one or more messages from the serving cell.

Example 7 may include the method of example 5, wherein the radio resources assignment command indicates that a frequency corresponding to the hosting cell is to be utilized for exchanging the data during the measurements radio gap.

Example 8 may include the method of example 1, further comprising exchanging hybrid automatic repeat request (HARQ) feedback for the data with the hosting cell during the measurements radio gap.

Example 9 may include the method of example 1, further comprising exchanging hybrid automatic repeat request (HARQ) feedback for the data with the serving cell outside of the measurements radio gap.

Example 10 may include the method of example 1, wherein the data comprises hybrid automatic repeat request (HARQ) feedback for second data exchanged with the serving cell prior to the measurements radio gap.

Example 11 may include the method of example 1, wherein exchanging the data includes exchanging multiple repetitions of the data with the hosting cell during the measurements radio gap.

Example 12 may include the method of example 1, further comprising identifying a measurements radio gaps pattern received from the serving cell, the measurements radio gaps pattern indicating one or more measurements radio gaps to be utilized for exchanging data with the hosting cell.

Example 13 may include the method of example 12, further comprising generating measurement reports or user equipment assistance information for transmission to the serving cell, the measurement reports or the user equipment assistance information to be utilized for determining the measurements radio gaps pattern.

Example 14 may include the method of example 1, further comprising identifying a command received from the serving cell, the command indicating that a next measurements radio gap is to be utilized for exchanging data with the hosting cell, wherein the measurements radio gap is the next measurements radio gap.

Example 15 may include the method of claim 14, wherein the command includes an indication that the configuration is to be utilized for exchanging data during the next measurements radio gap from a plurality of available configurations.

Example 16 may include the method of example 1, further comprising identifying radio resources assignment information received from the serving cell, the radio resources assignment information indicating radio resources to be utilized for exchanging data with the hosting cell in the next measurements radio gap.

Example 17 may include the method of example 16, wherein the radio resources assignment information includes an uplink (UL) grant or a downlink (DL) grant.

Example 18 may include the method of example 1, further comprising identifying a radio resources assignment received from the serving cell, the radio resources assignment indicating radio resources to be utilized for exchanging data with the hosting cell in a next measurements radio gap, wherein the measurements radio gap is the next measurement radio gap.

Example 19 may include the method of example 1, wherein a radio resources assignment is pre-configured with a radio resources assignment for the measurements radio gaps.

Example 20 may include the method of example 1, further comprising identifying a radio resources assignment received from the hosting cell during the measurements radio gap, the radio resources assignment indicating radio resources to be utilized for exchanging data with the hosting cell during the measurements radio gap.

Example 21 may include the method of example 1, further comprising identifying an abort command received from the hosting cell during the measurements radio gap, the abort command indicating that the measurements radio gap is to be aborted, and aborting the measurements radio gap based at least in part on identifying the abort command.

Example 22 may include the method of example 1, further comprising generating an uplink (UL) signal for transmission to the hosting cell, the UL signal to be utilized by the hosting cell for determining a UL time advance or UL power control, and identifying an indication of the UL time advance or the UL power control to be utilized for UL transmissions to the hosting cell.

Example 23 may include the method of example 1, further comprising identifying estimated uplink (UL) transmission information received from the serving cell, the estimated UL transmission information to be utilized for UL transmissions to the hosting cell.

Example 24 may include the method of example 23, wherein the estimated UL transmission information includes UL time advance information or UL power control information.

Example 25 may include the method of example 1, wherein the measurements radio gap is a first measurements radio gap, wherein the method further comprises performing hosting cell measurements related to link adaption, and generating a link adaption report for transmission to the serving cell or the hosting cell, the link adaption report including link adaption related measurement results produced by the hosting cell measurements.

Example 26 may include the method of example 25, wherein the link adaption report is for transmission to the hosting cell, and wherein the link adaption report is for transmission in a second measurements radio gap prior to the first measurements radio gap.

Example 27 may include the method of example 25, further comprising identifying a hosting cell measurements configuration received from the serving cell, wherein the hosting cell measurements are performed in accordance with the hosting cell measurements configuration.

Example 28 may include a method comprising determining that a user equipment (UE) has detected a hosting cell, configuring the hosting cell for data exchange with the UE during a measurements radio gap of the UE, the data exchange being performed for a serving cell, and configuring the UE for the data exchange with the hosting cell during the measurements radio gap.

Example 29 may include the method of example 28, wherein the measurements radio gap of the UE is a first measurements radio gap, and wherein the method further comprises configuring the UE to perform measurements of one or more frequencies during a second measurements radio gap occurring prior to the first measurements radio gap, and identifying a measurement report received from the UE, wherein determining that the UE has detected the hosting cell is based at least in part on the measurement report.

Example 30 may include the method of example 28, wherein configuring the hosting cell for the data exchange includes generating a request for the data exchange with the UE for transmission to the hosting cell, and identifying a response received from the hosting cell, the response related to the data exchange.

Example 31 may include the method of example 30, wherein the request includes a physical cell identifier (ID) for the hosting cell, UE measurements for the hosting cell, or a UE measurement pattern for a frequency of the hosting cell.

Example 32 may include the method of example 30, wherein the response includes an identifier (ID) for the UE when operating on the hosting cell, or a cell physical layer configuration for performance of the data exchange.

Example 33 may include the method of example 28, further comprising generating a transfer request for transmission to the hosting cell, the transfer request including an identifier of the UE, information related to the measurement radio gap, an amount of data to be exchanged via the data exchange, or a UE power measurement for the hosting cell, and identifying a transfer confirmation received from the hosting cell, the transfer confirmation indicating that the transfer request is accepted, and the transfer confirmation including an amount of bytes allocated for the data exchange or grant information for the data exchange.

Example 34 may include the method of example 28, further comprising generating a radio resources assignment command for transmission to the UE, wherein the radio resources assignment command includes an indication that a next radio gap instance is assigned for frequency measurements for a frequency of the hosting cell or radio sources information for the data exchange.

Example 35 may include the method of example 28, further comprising generating a data transmission payload for transmission to the hosting cell, the data transmission payload including data for the data exchange.

Example 36 may include the method of example 28, further comprising identifying a data payload received from the hosting cell, the data payload including data received by the hosting cell during the data exchange.

Example 37 may include the method of example 28, wherein a medium access control (MAC) layer entity of the serving cell communicates with a physical (PHY) layer entity of the hosting cell.

Example 38 may include the method of example 37, wherein the MAC layer entity generates downlink (DL) transmissions of the data exchange or processes uplink (UL) transmissions of the data exchange.

Example 39 may include the method of example 37, wherein a hybrid automatic repeat request (HARQ) entity of the serving cell performs HARQ operations related to the data exchange.

Example 40 may include the method of example 28, wherein the serving cell communicates with a medium access control (MAC) layer entity of the hosting cell, the MAC layer entity serving the UE for the data exchange.

Example 41 may include the method of example 40, wherein a hybrid automatic repeat request (HARQ) entity of the hosting cell performs HARQ operations related to the data exchange.

Example 42 may include the method of example 28, further comprising generating a measurement radio gaps pattern for transmission to the UE, the measurement radio gaps pattern indicating one or more measurements radio gaps to be utilized for one or more data exchanges between the UE and the hosting cell.

Example 43 may include the method of example 42, further comprising identifying one or more measurement reports or UE assistance information received from the UE, wherein the measurement radio gaps pattern is generated based at least in part on the one or more measurement reports or the UE assistance information.

Example 44 may include the method of example 28, further comprising generating a command for transmission to the UE, the command indicating a next measurements radio gap is to be utilized for the data exchange, wherein the measurements radio gap is the next measurements radio gap.

Example 45 may include the method of example 44, wherein the command includes a layer 1 (L1) command or a grant having radio resources allocation.

Example 46 may include the method of example 44, wherein the command includes a configuration identifier to be utilized for the data exchange.

Example 47 may include the method of example 28, further comprising generating a semi-static radio resources assignment configuration for transmission to the UE, the semi-static radio resources assignment configuration to be utilized for one or more data exchanges during one or more measurements radio gaps.

Example 48 may include the method of example 28, further comprising generating a radio resources assignment for transmission to the UE, the radio resources assignment to be utilized for a next measurements radio gap, wherein the measurements radio gap is the next measurements radio gap.

Example 49 may include the method of example 48, further comprising identifying radio resources assignment information received from the hosting cell, the radio resources assignment information utilized for generation of the radio resources assignment.

Example 50 may include the method of example 28, further comprising determining a condition for aborting the measurements radio gap has been fulfilled, and generate an abort command for transmission to the hosting cell, the abort command indicated that the measurements radio gap is to be aborted.

Example 51 may include the method of example 28, further comprising configuring the UE to generate a special uplink (UL) signal for transmission to the hosting cell, the special UL signal to be utilized for time advance determination or power control determination.

Example 52 may include the method of example 51, wherein the special UL signal is a first special UL signal, and wherein the method further comprises triggering the UE to generate a second special UL signal for transmission to the hosting cell, the second special UL signal to be utilized for a second time advance determination or a second power control determination.

Example 53 may include the method of example 28, further comprising generating an estimated uplink (UL) transmission information message for transmission to the UE, the estimated UL transmission information message including estimated UL transmission information for the hosting cell.

Example 54 may include the method of example 53, wherein the estimated UL transmission information message includes time advance information for the hosting cell or power control information for the hosting cell.

Example 55 may include the method of example 28, further comprising configuring the UE to perform measurements for specific resources of the hosting cell, the measurements to be utilized for link adaption.

Example 56 may include the method of example 55, further comprising identifying measurement configuration information received from the hosting cell, wherein the UE is configured to perform the measurements based at least in part on the measurement configuration information.

Example 57 may include a method comprising identifying a data exchange request received from a serving cell, the data exchange request requesting performance of one or more data exchanges with a user equipment (UE) on behalf of the serving cell during one or more measurements radio gaps, generating a confirmation for transmission to the serving cell, the confirmation indicating that the one or more data exchanges are accepted, and performing a data exchange with the UE during a measurements radio gap.

Example 58 may include the method of example 57, wherein the data exchange request includes a physical identifier (ID) for the UE, UE measurements for a hosting cell, or a UE measurement pattern for a frequency of the hosting cell.

Example 59 may include the method of example 57, wherein the confirmation includes an identifier (ID) to be utilized by the UE while operating on a hosting cell or a physical layer configuration for the UE for performance of the data exchange.

Example 60 may include the method of example 57, further comprising identifying transfer request information received from the serving cell, the transfer request information related to the measurements radio gap, and generating a transfer request information confirmation for transmission to the serving cell based at least in part on the transfer request information.

Example 61 may include the method of example 60, wherein the transfer request information includes an identifier (ID) of the UE, radio gap instance information related to the measurements radio gap, an amount of data to be exchanged in the data exchange, UE measurement values for a hosting cell, or a start time and duration of the measurements radio gap.

Example 62 may include the method of example 60, wherein the transfer request information confirmation includes an amount of bytes allocated for the data exchange or grant information for the data exchange.

Example 63 may include the method of example 57, further comprising identifying a downlink (DL) payload from the serving cell, the DL payload including DL data to be provided to the UE in the data exchange, and generating a DL transmission for transmission to the UE during the measurements radio gap, the DL transmission including the DL data.

Example 64 may include the method of example 57, further comprising identifying uplink (UL) data received from the UE during the measurements radio gap, and generating a UL payload for transmission to the serving cell, the UL payload including the UL data.

Example 65 may include the method of example 57, wherein data is exchanged with the serving cell and the UE via a physical (PHY) layer entity of a hosting cell.

Example 66 may include the method of example 57, wherein a dedicated medium access control (MAC) entity of a hosting cell serves the data exchanged in the data exchange during the measurements radio gap.

Example 67 may include the method of example 66, wherein a dedicated hybrid automatic repeat request (HARQ) entity of the hosting cell is to perform HARQ operations for the data exchange.

Example 68 may include the method of example 57, wherein the data exchange includes exchange of data with the UE during the measurements radio gap, and exchange of hybrid automatic repeat request (HARQ) feedback with the UE during the measurements radio gap, the HARQ feedback related to the data.

Example 69 may include the method of example 57, wherein the data exchange includes exchange of hybrid automatic repeat request (HARQ) feedback with the UE during the measurements radio gap, the HARQ feedback related to data exchanged outside of the measurements radio gap.

Example 70 may include the method of example 57, wherein the data exchange includes exchange of one or more repetitions of data with the UE during the measurements radio gap.

Example 71 may include the method of example 57, further comprising generating a radio resources assignment information communication for transmission to the serving cell, the radio resources assignment information communication including radio resources assignment information for the data exchange.

Example 72 may include the method of example 57, further comprising generating a radio resources assignment command for transmission to the UE during the measurements radio gap, the radio resources assignment command including radio resources assignments for the data exchange.

Example 73 may include the method of example 57, further comprising identifying an abort command received from the serving cell, the abort command indicating the measurements radio gap is to be aborted, and generating an abort gap command for transmission to the UE during the measurements radio gap, the abort gap command indicating that the UE is to abort the measurements radio gap and return to operation with the serving cell.

Example 74 may include the method of example 57, further comprising identifying an uplink (UL) initial signal received from the UE during the measurements radio gap, determining a time advance or a power control based at least in part on the UL initial signal, and generating a UL transfer information message for transmission to the UE during the measurements radio gap, the UL transfer information message including the time advance or the power control.

Example 75 may include the method of example 74, further comprising generating a trigger message for transmission to the UE, the trigger message to cause the UE to provide the UL initial signal.

Example 76 may include the method of example 74, further comprising generating a trigger message for transmission to the serving cell, the trigger message to cause the serving cell to request that the UE provide the UL initial signal.

Example 77 may include the method of example 74, wherein the UL initial signal includes a preamble used for determining the time advance or the power control.

Example 78 may include the method of example 57, further comprising identifying link adaption related measurement results received from the UE, determining a link adaption based at least in part on the link adaption related measurement results, and utilizing the link adaption for a next measurements radio gap.

Example 79 may include the method of example 57, further comprising identifying link adaption related measurement results received from the serving cell;

determining a link adaption based at least in part on the link adaption related measurement results, and utilizing the link adaption for a next measurements radio gap.

Example 80 may include a method comprising determining a condition for skipping a next measurements radio gap is fulfilled, and generating a measurements radio gap skip command for transmission to a user equipment (UE), the measurements radio gap skip command to cause the UE to skip the next measurements radio gap.

Example 81 may include the method of example 80, wherein the measurements radio gap skip command is a layer 1 (L1) command.

Example 82 may include the method of example 80, wherein the measurements radio gap skip command includes one or more grants for data transfer scheduled within the next measurements radio gap.

Example 83 may include a method comprising identifying a measurements radio gap skip command received from a serving cell, and skipping a next measurements radio gap based at least in part on the measurements radio gap skip command.

Example 84 may include the method of example 83, wherein the measurements radio gap skip command is received via layer 1 (L1) signaling.

Example 85 may include the method of example 83, wherein the measurements radio gap skip command includes one or more grants for data transfer scheduled within the next measurements radio gap.

Example 86 may include the method of example 83, wherein skipping the next measurements radio gap includes allowing data transfer to be scheduled with the serving cell during the next measurements radio gap.

Example 87 may include a method comprising determining a condition for a user equipment (UE) to implement one or more measurements radio gaps is fulfilled, and generating an enablement command for transmission to the UE, the enablement command indicating that the UE is to implement the one or more measurements radio gaps.

Example 88 may include the method of example 87, wherein the one or more measurements radio gaps include a single measurements radio gap instance.

Example 89 may include the method of example 87, wherein the one or more measurements radio gaps include multiple measurements radio gap instances.

Example 90 may include the method of example 87, wherein the enablement command indicates that the UE is to implement measurement radio gap instances until a subsequent command is received.

Example 91 may include the method of example 87, further comprising generating an enabled measurement radio gap instance configuration for transmission to the UE, the enabled measurement radio gap instance configuration indicating a start offset for the one or more measurements radio gaps, a duration for the one or more measurements radio gaps, or a periodicity of the one or more measurements radio gaps.

Example 92 may include the method of example 87, wherein the enablement command indicates a start offset for the one or more measurements radio gaps, a duration for the one or more measurements radio gaps, or a periodicity of the one or more measurements radio gaps.

Example 93 may include a method comprising identifying an enablement command received from a serving cell, and implementing one or more measurements radio gaps based at least in part on the enablement command.

Example 94 may include the method of example 93, wherein the enablement command indicates that a single measurements radio gap instance is to be implemented, and wherein implementing the one or more measurements radio gaps includes implementing the single measurements radio gap instance.

Example 95 may include the method of example 93, wherein the enablement command indicates that multiple measurements radio gap instances are to be implemented, and wherein implementing the one or more measurements radio gaps includes implementing the multiple measurements radio gap instances.

Example 96 may include the method of example 93, wherein the enablement command indicates that measurements radio gap instances are to be implemented until a subsequent command is received, and wherein implementing the one or more measurements radio gaps includes implementing measurements radio gap instances until the subsequent command is received.

Example 97 may include the method of example 93, further comprising identifying an enabled measurement radio gap instance configuration received from the serving cell, and determining a start offset for the one or more measurements radio gaps, a duration for the one or more measurements radio gaps, or a periodicity of the one or more measurements radio gaps based at least in part on the enabled measurement radio gap instance configuration.

Example 98 may include the method of example 93, further comprising determining a start offset for the one or more measurements radio gaps, a duration for the one or more measurements radio gaps, or a periodicity of the one or more measurements radio gaps based at least in part on the enablement command.

Example 99 may include a method comprising determining that a portion of a measurement gap instance is not to be utilized for measurement operations, and generating, for transmission to a base station, a communication that includes information for the portion of the measurement gap instance.

Example 100 may include the method of example 99, further comprising identifying one or more data transfer assignments received from the base station, and monitoring one or more serving cells for one or more data transfers corresponding to the one or more data transfer assignments during the portion of the measurement gap instance.

Example 101 may include the method of example 99, wherein the information for the portion of the measurement gap instance includes a duration of the portion of the measurement gap instance.

Example 102 may include the method of example 99, wherein the information for the portion of the measurement gap instance includes a pattern for the measurement gap instance.

Example 103 may include the method of example 102, wherein the pattern for the measurement gap instance includes a start of the measurement gap instance and a periodicity related to the measurement gap instance.

Example 104 may include the method of example 99, further comprising determining that low latency critical uplink (UL) data is pending for transmission, and determining that a primary serving cell is in good channel conditions, wherein the communication is generated based at least in part on the determination that the low latency UL data is pending for transmission and the determination that the primary serving cell is in good channel conditions.

Example 105 may include the method of example 104, wherein determining the primary serving cell is in good channel conditions includes determining that a power for the primary serving cell exceeds a threshold power.

Example 106 may include a method comprising identifying an indication of a portion of a measurement gap that is not to be utilized for measurement operations, the indication received from a user equipment (UE) to implement the measurement gap, and generating a data transfer assignment for transmission to the UE, the data transfer assignment for a data transfer operation to be performed during the portion of the measurement gap.

Example 107 may include an apparatus comprising means to perform one or more elements of a method described in or related to any of examples 1-106, or any other method or process described herein.

Example 108 may include one or more non-transitory computer-readable media comprising instructions to cause an electronic device, upon execution of the instructions by one or more processors of the electronic device, to perform one or more elements of a method described in or related to any of examples 1-106, or any other method or process described herein.

Example 109 may include an apparatus comprising logic, modules, or circuitry to perform one or more elements of a method described in or related to any of examples 1-106, or any other method or process described herein.

Example 110 may include a method, technique, or process as described in or related to any of examples 1-106, or portions or parts thereof.

Example 111 may include an apparatus comprising: one or more processors and one or more computer-readable media comprising instructions that, when executed by the one or more processors, cause the one or more processors to perform the method, techniques, or process as described in or related to any of examples 1-106, or portions thereof.

Example 112 may include a signal as described in or related to any of examples 1-106, or portions or parts thereof.

Example 113 may include a datagram, information element, packet, frame, segment, PDU, or message as described in or related to any of examples 1-106, or portions or parts thereof, or otherwise described in the present disclosure.

Example 114 may include a signal encoded with data as described in or related to any of examples 1-106, or portions or parts thereof, or otherwise described in the present disclosure.

Example 115 may include a signal encoded with a datagram, IE, packet, frame, segment, PDU, or message as described in or related to any of examples 1-106, or portions or parts thereof, or otherwise described in the present disclosure.

Example 116 may include an electromagnetic signal carrying computer-readable instructions, wherein execution of the computer-readable instructions by one or more processors is to cause the one or more processors to perform the method, techniques, or process as described in or related to any of examples 1-106, or portions thereof.

Example 117 may include a computer program comprising instructions, wherein execution of the program by a processing element is to cause the processing element to carry out the method, techniques, or process as described in or related to any of examples 1-106, or portions thereof.

Example 118 may include a signal in a wireless network as shown and described herein.

Example 119 may include a method of communicating in a wireless network as shown and described herein.

Example 120 may include a system for providing wireless communication as shown and described herein.

Example 121 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory, computer-readable media having instructions that, when executed, cause processing circuitry to:
identify a data exchange request received from a serving cell, the data exchange request requesting performance of one or more data exchanges with a user equipment (UE) on behalf of the serving cell during one or more measurements radio gaps;
generate a confirmation for transmission to the serving cell, the confirmation indicating that the one or more data exchanges are accepted; and
perform a data exchange with the UE during a measurements radio gap.

2. The one or more non-transitory, computer-readable media of claim 1, wherein the data exchange request includes a physical identifier (ID) for the UE, UE measurements for a hosting cell, or a UE measurement pattern for a frequency of the hosting cell.

3. The one or more non-transitory, computer-readable media of claim 1, wherein the confirmation includes an identifier (ID) to be utilized by the UE while operating on a hosting cell or a physical layer configuration for the UE for performance of the data exchange.

4. The one or more non-transitory, computer-readable media of claim 1, wherein the instructions, when executed, further cause the processing circuitry to:
identify transfer request information received from the serving cell, the transfer request information related to the measurements radio gap; and
generate a transfer request information confirmation for transmission to the serving cell based at least in part on the transfer request information.

5. The one or more non-transitory, computer-readable media of claim 1, wherein the instructions, when executed, further cause the processing circuitry to:
identify a downlink (DL) payload from the serving cell, the DL payload including DL data to be provided to the UE in the data exchange; and
generate a DL transmission for transmission to the UE during the measurements radio gap, the DL transmission including the DL data.

6. The one or more non-transitory, computer-readable media of claim 1, wherein the data exchange includes:
exchange of data with the UE during the measurements radio gap; and
exchange of hybrid automatic repeat request (HARQ) feedback with the UE during the measurements radio gap, the HARQ feedback related to the data.

7. The one or more non-transitory, computer-readable media of claim 1, wherein the data exchange includes:
exchange of hybrid automatic repeat request (HARQ) feedback with the UE during the measurements radio gap, the HARQ feedback related to data exchanged outside of the measurements radio gap.

8. The one or more non-transitory, computer-readable media of claim 1, wherein the instructions, when executed, further cause the processing circuitry to:
identify an uplink (UL) initial signal received from the UE during the measurements radio gap;
determine a time advance or a power control based at least in part on the UL initial signal; and
generate a UL transfer information message for transmission to the UE during the measurements radio gap, the UL transfer information message including the time advance or the power control.

9. The one or more non-transitory, computer-readable media of claim 1, wherein the instructions, when executed, further cause the processing circuitry to:
identify link adaption related measurement results received from the UE;
determine a link adaption based at least in part on the link adaption related measurement results; and
utilize the link adaption for a next measurements radio gap.

10. The one or more non-transitory, computer-readable media of claim 1, wherein the instructions, when executed, further cause the processing circuitry to:
identify link adaption related measurement results received from the serving cell;
determine a link adaption based at least in part on the link adaption related measurement results; and
utilize the link adaption for a next measurements radio gap.

11. An apparatus comprising:
processing circuitry to:
determine that a portion of a measurement gap instance is not to be utilized for measurement operations; and
generate, for transmission to a base station, a communication that includes information for the portion of the measurement gap instance
interface circuitry coupled with the processing circuitry, the interface circuitry to communicatively couple the processing circuitry with a component of a device.

12. The apparatus of claim 11, wherein the processing circuitry is further to:
identify one or more data transfer assignments received from the base station; and
monitor one or more serving cells for one or more data transfers corresponding to the one or more data transfer assignments during the portion of the measurement gap instance.

13. The apparatus of claim 11, wherein the information for the portion of the measurement gap instance includes a duration of the portion of the measurement gap instance.

14. The apparatus of claim 11, wherein the information for the portion of the measurement gap instance includes a pattern for the measurement gap instance.

15. The apparatus of claim 14, wherein the pattern for the measurement gap instance includes a start of the measurement gap instance and a periodicity related to the measurement gap instance.

16. The apparatus of claim 11, wherein the processing circuitry is further to:
determine that low latency critical uplink (UL) data is pending for transmission; and
determine that a primary serving cell is in good channel conditions, wherein the communication is generated based at least in part on the determination that the low latency UL data is pending for transmission and the determination that the primary serving cell is in good channel conditions.

17. The apparatus of claim 16, wherein to determine the primary serving cell is in good channel conditions includes to determine that a power for the primary serving cell exceeds a threshold power.

18. A method comprising:
determining a condition for skipping a next measurements radio gap is fulfilled; and
generating a measurements radio gap skip command for transmission to a user equipment (UE), the measurements radio gap skip command to cause the UE to skip the next measurements radio gap.

19. The method of claim 18, wherein the measurements radio gap skip command is a layer 1 (L1) command.

20. The method of claim 18, wherein the measurements radio gap skip command includes one or more grants for data transfer scheduled within the next measurements radio gap.
